(19) United States
(12) Patent Application Publication
(10) Pub. No.: US 2025/0111973 A1
(43) Pub. Date: Apr. 3, 2025

(54) Reprogrammable Morphing Sheets Via Magnetically Controlled Folding and Articulated Components

(71) Applicant: The Trustees of the University of Pennsylvania, Philadelphia, PA (US)

(72) Inventors: Cynthia Sung, Philadelphia, PA (US); Gabriel Unger, Philadelphia, PA (US)

(21) Appl. No.: 18/904,271

(22) Filed: Oct. 2, 2024

Related U.S. Application Data
(60) Provisional application No. 63/587,470, filed on Oct. 3, 2023.

(51) Int. Cl. H01F 7/06; H01F 7/20

(52) U.S. Cl. CPC H01F 7/064; H01F 7/20

(57) ABSTRACT

A method, comprising: applying a magnetic field to a magnetizable substrate sheet, the magnetizable substrate sheet comprising a first rotatable element, the magnetic field rotating the first rotatable element as to convert the magnetizable substate sheet to a second configuration in which second configuration the first rotatable element magnetically affixes to a second element of the magnetizable substrate sheet. A component, comprising: a plurality of articulable segments arranged circumferentially so as to define a first collapsable frustum and a second collapsable frustrum, the first collapsable frustum and the second collapsable frustum extending away from their respective bases and converging toward one another, the first collapsable and second collapsable frustum converging at a plane and the component defining therein an opening at the plane, the component configured such that the first and second collapsable frustrum are collapsable toward one another so as to attain one or more stable collapse states.

### CROSS-REFERENCE TO RELATED APPLICATIONS

This application claims priority to and the benefit of U.S. Provisional Application No. 63/587,470, “Reprogrammable Morphing Sheets Via Magnetically Controlled Folding And Articulated Components,” filed on Oct. 3, 2023. All foregoing applications are incorporated herein by reference in their entireties for any and all purposes.

### TECHNICAL FIELD

The present disclosure relates to the field of soft robotics.

### BACKGROUND

Programmable matter are systems with the ability to change their shape or mechanical properties in a controllable manner on-demand. In natural systems, for example, animals adapt their visual appearance, texture, or even bulk structure to hide, hunt, and communicate with each other. Imagine now extending upon these capabilities to create everyday objects that autonomously morph their form: furniture that can serve alternately as chair, table, or shelves: smartphones that grow legs and crawl away, then shrink back to fit in a pocket: or cars that change their tire size or treads to fit the terrain.

These systems require integration of mechanical structure, sensing, actuation, and control to enact such a change consistently and robustly over a variety of desired geometries and configurations. Recent advancements in mechanisms, materials, and digital fabrication have given self-assembling and self-reconfigurable structures the ability to change their shape, morphology, texture, color, or mechanical properties such as stiffness and damping.

Although these materials systems have been successfully demonstrated on a wide range of shapes with complex kinematics, the systems as yet lack execution-time versatility. That is, the morphing transformation enacted by these systems are determined upon fabrication, and thus, the ability to reprogram the system to achieve different configurations as needed is lost. Accordingly, there is a long-felt need in the field for improved programmable matter systems.

### SUMMARY

Provided here is, inter alia, a reprogrammable matter system that changes its shape in a controllable manner in real time and on-demand. The system uses origami-inspired fabrication for self-assembly and repeated self-reconfiguration. By writing a magnetic program onto a thin laminate and applying a localized external magnetic field, we control the sheet to self-fold into a 3D structure within seconds. The magnetic program can be written at millimeter resolution over hundreds of programming cycles and folding steps. Using a fully automated program-and-fold process, we demonstrate how the same sheet can be reprogrammed to fold and unfold into multiple shapes. The approach is scalable to structures at a variety of sizes and resolutions. Finally, we demonstrate how electronic components can be incorporated into the sheet to produce functional structures such as a foldable display. The system has distinct advantages over existing programmable matter systems in its versatility and ability to support potentially any folding sequence, and represents a new advancement in digital fabrication where custom parts can not only be fabricated, but also reused and recycled.

In meeting the described long-felt needs, the present disclosure provides a method, comprising: applying a magnetic field from a magnetic field source to a magnetizable substrate sheet that is in a first configuration, the magnetizable substrate sheet comprising a first rotatable element that (i) comprises a first magnetic pattern and (ii) is configured to rotate about an axis extending in a first direction, the first magnetic pattern comprising a region of a first magnetic polarity, the magnetic field rotating the first rotatable element as to convert the magnetizable substate sheet to a second configuration in which second configuration the first rotatable element magnetically affixes to a second element of the magnetizable substrate sheet, the second element having a second magnetic pattern thereon, the second magnetic pattern comprising a second magnetic polarity, and the second element optionally being rotatable.

Also provided is a system, the system comprising: a magnetic write head, the magnetic write head being configured to define a magnetic pattern on a magnetizable substrate sheet; and a magnetic coil, the magnetic coil being configured to apply a magnetic field to a magnetizable substrate sheet so as to effect folding of the magnetizable substrate sheet.

Further disclosed is a method, comprising: determining a folding pattern and a folding sequence for converting a magnetizable substrate sheet from an initial folding state to a final folding state, the magnetizable substrate sheet comprising a first rotatable element that (i) comprises a first magnetic pattern and (ii) is configured to rotate about an axis extending in a first direction; and defining on the magnetizable substrate sheet a pixelated magnetic pattern that corresponds to a folding pattern and a folding sequence for converting of the magnetizable substrate sheet from the initial folding state to the final folding state.

Also provided is a method, comprising: with a magnetizable substrate sheet that comprises (a) a plurality of rotatable elements that each (a1) comprises a respective magnetic pattern and (a2) is configured to rotate about an axis extending in a direction, and (b) a thermoplastic arranged so as oppose rotation by a respective rotatable element when the thermoplastic material is in a cool state and permit rotation by the element when the thermoplastic material is in a warmed state, applying a schedule of magnetic fields and heat so as to convert the magnetizable substrate sheet from a first folding state to a second folding state.

Further provided is a component, comprising: a plurality of articulable segments arranged circumferentially so as to define a first collapsable frustum and a second collapsable frustrum, each of the first collapsable frustum and the second collapsable frustum having a base, the first collapsable frustum and the second collapsable frustum extending away from their respective bases and converging toward one another, the first collapsable and second collapsable frustum converging at a plane and the component defining therein an opening at the plane, the component configured such that the first collapsable frustum and second collapsable frustrum are collapsable toward one another so as to attain one or more stable collapse states, the opening attaining at a given stable collapse state a cross-sectional dimension associated with that stable collapse state, and the greater a degree of collapse of the first collapsable frustum and the second collapsable frustum, the smaller the cross-sectional dimension of the opening. Without being bound to any particular theory or embodiment, such components can be used in applications where a controllable constriction is desired, surgical applications being one such application.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1: Magnetic re-programmable matter system: magnetic laminate origami sheets are automatically written with a pixelized magnetic program and folded into 3D shapes. These structures can then be unfolded, reprogrammed, and refolded into new structures.

FIGS. 2A-2D: System overview. FIG. 2A-Magnetically reprogrammable matter folds using a multistep process involving programming a laminate sheet with a magnetic write head on linear rails. Large magnetic coils then generate external magnetic fields to fold the sheet. The entire system is controlled using a software planner and controller. FIG. 2B-Magnetization of fold pattern. When two neighboring faces have opposite polarity, they form a hinge capable of folding in four different ways depending on the direction of the external magnetic field. FIG. 2C—The planner converts a user-inputted structure into a sequence of fold patterns and magnetic programs for the folding steps. The system then converts the pattern into a fabrication drawing for the reprogrammable sheet and the magnetic programs into machine code. The reprogrammable sheet is iteratively programmed and then folded for each of the folding steps until the final structure is realized.

FIG. 2D—The sheet is constructed by first laser cutting mirror-image drawings of the desired fold pattern with gaps at the folds. The excess material is removed and a mesh material is inserted. The sheet is then folded in half to align and adhere the magnetic faces around the mesh.

FIGS. 3A-3C. Magnetic write head. Scale bars are 20 mm. FIG. 3A-CAD model of magnetic write head with associated magnetic flux lines from narrow to the wide end. FIG. 3B-Physical prototype showing write head attached to Cameo Silhouette and a plastic guard. FIG. 3C-PWM vs surface field on programmed magnetic sheet.

FIGS. 4A-4B. Generation of machine code for magnetization of the sheet. FIG. 4A-Graphical user interface for assigning magnetic polarities to the faces of the pattern. The user can choose to assign faces as North, South, or Clear. The user additionally chooses the coil (X or Z direction) to use for folding. The user can program entire folding sequences by adding folding steps. FIG. 4B—Example output text file representing pixelated magnetic program used by the Python driver. The first line of the file indicates the resolution of programming, the second line indicates which coil to use for folding, and the rest of the file contains the matrix values for programming.

FIGS. 5A-5E (ii). Evaluation of programming repeatability over single and multiple layers. Measurements of the surface magnetic field of a single-pixel programmed with FIG. 5A alternating North and South signals, FIG. 5B alternating South and Clear signals, FIG. 5 alternating North and Clear signals, and FIG. 5D repeated North signals. FIG. 5E Results of multilayer test. FIG. 5E (i) Magnetic image of step sample. FIG. 5E (ii) Average magnetic strength of each pixel row in the first column of the sample.

FIGS. 6A-6D. Magnetic images of programming the checkerboard pattern at various resolutions. FIG. 6A-5 mm resolution checkerboard imaged at 1 mm resolution. FIG. 6B 3 mm resolution checkerboard imaged at 0.5 mm resolution. FIG. 6C-2 mm resolution checkerboard imaged at 0.5 mm resolution. FIG. 6D-1 mm resolution checkerboard imaged at 0.05 mm resolution.

FIGS. 7A-7E (iii). Sample structures created using our system. Scale bars are 10 mm. FIG. 7A-Book fold pattern. FIG. 7B-Boat pattern. FIG. 7C-Cup pattern. FIG. 7D—Airplane pattern. FIG. 7E-Universal fold pattern folding into an airplane. FIG. 7E (i)—Unfolded 2×2 tessellated universal fold pattern. FIG. 7E (ii)—In the first step, the two top corners fold in along diagonal folds. FIG. 7E (iii)—In the second step, the body and wings fold to complete the airplane.

FIG. 8. Programming and folding steps for the (row 1) boat, (row 2) box, (row 3) cup, and (row 4) airplane structures. The first column shows the fabricated flat sheet with gaps at the fold lines. The second column shows the magnetic image of the programmed sheet. The third column shows the resulting folded shape. The direction of the external magnetic field used is indicated in the bottom right corner. For the cup and airplane pattern, which require multiple folding steps, column 4 shows the magnetic image of the second programming step, and column 5 the resulting folded shape. Scale bars are 20 mm.

FIGS. 9A-9E. Universal fold pattern. Scale bars are 20 mm. FIG. 9A-Unfolded universal fold pattern. FIG. 9B-Boat final folded shape. FIG. 9C-Airplane final folded shape. FIG. 9D-Magnetic image of a programmed pattern for a boat. FIG. 9E-Magnetic image of programmed pattern for airplane.

FIGS. 10A-10D. Repeated folding and unfolding of the reprogrammable sheet fabricated in a 2×2 universal fold pattern. Scale bars are 20 mm. FIG. 10A—The flat sheet is programmed to fold in half laterally, then FIG. 10B in half horizontally. FIG. 10C—It can then unfold horizontally, FIG. 10D, and laterally in the reverse folding sequence.

FIGS. 11A-11G. Grayscale images of foldable electronic display. Scale bars are 20 mm. FIG. 11A—The unfolded display is a 3×4 universal fold pattern with copper traces and LEDs on each face. FIG. 11B—To fold into a P, the first step is to fold the bottom right corner. FIG. 11C—The second step is to fold the left side. FIG. 11D-When the display is turned on, the LEDs light up into a red and blue pattern. FIG. 11E-Magnetic program used to generate the required folding sequence. FIG. 11F-Magnetic image of the program on the fabricated sheet. FIG. 11G-Reference University of Pennsylvania logo used for the display.

FIGS. 12A-12B. Fabrication procedure for sheet that includes thermoplastic material. As shown, FIG. 12A, First a thin layer is 3D printed, then the mesh material is placed over top, then the final layer is printed forming a PLA-mesh layer. FIG. 12B—The sheet is constructed by first laser cutting mirror-image drawings of the desired fold pattern with gaps at the folds. The excess material is then removed. The mesh material embedded with the thermoplastic is then placed between onto one of the faces of the magnetic material, and the other side folded over. This step aligns the two mirror-image patterns cut into the magnetic film and adheres the faces to each other to keep the polyester mesh in place. The painter's tape backing is removed, leaving only the magnetic and mesh layers. The resulting pattern has thick magnetic material only on the faces and a thin thermoplastic layer at the folds. Additionally the mesh layer can be forgone if the entire samples is allowed to be rigid, that is none of the faces are foldable without the heating element.

FIGS. 13A-13D. Example heating and folding steps, showing the use of a thermoplastic material: as shown, the sheet can be moved between a first rigid state and a second rigid state. FIG. 13A provides a cross section view of sheet. FIG. 13B—The sample is first heated up to the glass transition temperature, and then the external magnetic field is turned on. FIG. 13C—The heating element is turned off, and the magnetic field is left one while the sample cools down and solidifies. FIG. 13D—Example patterns of how the heating and folding can be used in conjunction with a universal pattern to be folded, and solidified into different final structures.

FIG. 14. Examples of the folding and heating process using a heat gun. Top Left: Boat Pattern folding into a boat. Top Right: Universal Fold Pattern Folding into a boat. Bottom Left: Universal fold pattern folding into an airplane step 1. Bottom right: Universal fold pattern folding into an airplane step 2.

FIGS. 15A-15B. Example heating and folding process. Due to the added thermoplastic, the samples now become rigid after folding. To evaluate the application of theses we performed two tests. Passive loading test FIG. 15A: First the sample is folded, and then weight is applied. These structures once folded, demonstrate a great capacity for passive loading thanks to the rigidity of the PLA thermoplastic layer. Active loading testing FIG. 15B: Weight is placed on the sample, and then the sample attempts to fold. Here we demonstrate a structure capable of folding, latching into place, and then supporting over 50× its own weight (passively), and approximately ½ its body weight for active folding.

FIG. 16. Exemplary folding process. By changing the pulse width modulation (PWM) signal sent to the motor driver, we can change the magnitude of the external magnetic field. Using this we can achieve varying angles between 0 and 90 degrees. With the embedded latching, the sample could be heated and then folded to an in between angle and then solidify there.

FIG. 17. Exemplary fabrication process. As shown, one can print a layer of a polymer-such as PLA-on a print bed. A mesh or other flexible material can be disposed on the polymer layer A further polymer layer can then be placed over the mesh or other flexible material.

FIG. 18. Exemplary fabrication process. As shown, one can print a layer of a polymer-such as PLA-on a print bed. The process can then follow the procedure of FIG. 17, except that some of the mesh or other flexible material can be replaced with a thermoplastic or other thermosensitive material. In this way, one can construct a pattern that includes regions of thermoplastic that confer rigidity onto the pattern and also includes regions of mesh that confer flexibility on the pattern and do not require heating in order to fold. But to fold the entirety of such a pattern, one must apply heat so as to soften the thermoplastic material to allow for folding of that thermoplastic material. It should be understood that polymers that respond to other stimuli besides heat can be used. As an example, polymers that soften with applied current can be used. Conductive propylene-based elastomers (cPBE) are polymers that change their mechanical rigidity when powered by electrical current. Specifically, these materials soften when a current is applied, allowing for reversible changes in stiffness. As another example, moisture-softening wood can be used. In traditional woodworking, moisture softens the wood, allowing it to bend into organic shapes. Once dried, the wood retains its new shape and becomes rigid again. This can be implemented, for example in systems using two types of wood that swell differently in response to moisture, causing them to fold at various angles. One can, for example, use a thin laminate of wood that softens under moisture and bends. As a further example, one can utilize magnetocaloric materials with magnetic induction. Such materials exhibit an effect where they heat up when exposed to a magnetic field and cool down when the field is removed. One can embed magnetic particles into a polymer layer: when exposed to a rotating magnetic field, the polymer will heat and soften without needing a direct heating element. As a further example one can utilize Joule heating of polymers. Similar to magnetic induction, certain polymers generate heat when an electrical current is applied, a process known as Joule heating. This can be used to soften polymers by reducing their stiffness in response to the heat generated. One can thus place a layer of copper or other conductor adjacent to the polymer add current to heat the polymer. One can also use a thermoplastic material that is electrically conductive and passes current directly through the material, causing it to decrease in stiffness when it heats up.

FIG. 19. Example component according to the present disclosure. As shown, the frustums of the component can be collapsed by application of a magnetic field, which collapse in turn reduces the size of the internal opening of the component.

FIGS. 20A-20C. FIG. 20A-Generalized SREBO pattern with labeled variables and components. FIG. 20B-Folded 3D SREBO with relevant design measures labeled. FIG. 20C-Photograph of the compression testing setup, with the SREBO model placed in a 3D-printed fixture and secured to an MTS Electromechanical Test Machine.

FIGS. 21A-21C. FIG. 21A-Average maximum force peaks of SREBO models across 0.001″, 0.002″, and 0.003″ thickness PET scales. FIG. 21B-Average maximum force peaks of SREBO models across 2×, 2.5×, 3×, 4×, 5×, and 6× size scales. FIGS. 21C-Average maximum force peaks of SREBO models with 30°, 40°, 45°, 55°, 60°, and 65° alpha angles. For all graphs, error bars are plotted as standard deviation.

FIGS. 22A-22B. FIG. 22A-Visualization of force testing for single-fold and multi-fold SREBOs. The average force curve for Alpha-1 (top) (n=9), Alpha-2 (center) (n=14), and the overlaid Alpha-1-2 (bottom) (n=10) are plotted on a standard axis. Error is plotted as the standard deviation of the samples averaged. FIG. 22B—Normalized force ratios across scales 2×, 3×, 4×, 5×, and 6× size scales. The normalized force ratio is calculated as the average force peak maximum of Alpha-1-2 models divided by the average force peak maximum of their Alpha-1 or Alpha-2 counterparts, respectively.

FIG. 23. Provides example fold parameters for a multistable structure: a multistable structure is represented by the “State-Switch” image.

FIG. 24A. Provides exemplary governing equations and constraints for a multistable structure according to the present disclosure. Also provided are a) the unfolded S-REBO fold pattern on a sheet, b) A side view of the folded and assembled S-REBO snapping between three stable states, c) A top-down view of folded and assembled S-REBO snapping between three stable states: first stable state, second stable state, and fully-collapsed. The dashed lines in a) and b) represent perforations. The inner radius, ri, decreases when the structure's height decreases and increases when the structure's height increases.

FIG. 24B. Provides a depiction of bi-stable component according to the present disclosure as well as related governing equations.

FIG. 24C. Provides mechanical characterization of an example multistable component according to the present disclosure.

FIG. 25. Visual of full (left), half (middle), and full-half OP AB prototypes. The full prototype has the largest stability angle while the half prototype has the smallest stability angle. Full-half contains both and is tristable. Also shown are vents that can be placed between folds, which vents can be cuts in the material.

FIG. 26. A visual of the location of vents on a full-half prototype. Adding the larger stability angle and its diagonal fold helps to control the length of the vents and confine each set of vents to one fold unit.

FIG. 27. Exemplary force vs. displacement plots for components according to the present disclosure.

FIG. 28. Depiction of the effect of different magnetic fields on an example component according to the present disclosure.

FIG. 29. A component with oppositely magnetized panels on the upper and lower frustra can be placed in a magnetic field (in direction of grey arrows) to enable collapsing (right) or expanding (left) of the OPAB.

FIG. 30. An output plot of the magnetic programming-by-pixel procedure. Positive (red) represents northern direction and negative (blue) represents southern direction.

FIG. 31. Illustrations of the internal radius of a component according to the present disclosure following exposure to different magnetic fields.

FIG. 32. An image of an exemplary component according to the present disclosure.

FIG. 33. An image of an exemplary component according to the present disclosure. As compared to the component of FIG. 32, the interior aperture of the component of FIG. 33 is not defined by a square formed by four edges: instead, the interior aperture of the component is defined by a plurality of smaller or shorted edges, thereby making the interior aperture more rounded.

FIG. 34 provides an example map for certain parameters identified herein.

FIG. 35 provides mean force-displacement curves results for the 7x-scale half and full-half prototypes. Error bars representing the mean standard deviation for each mean curve are also plotted. “Vents” are explained in the next subsection.

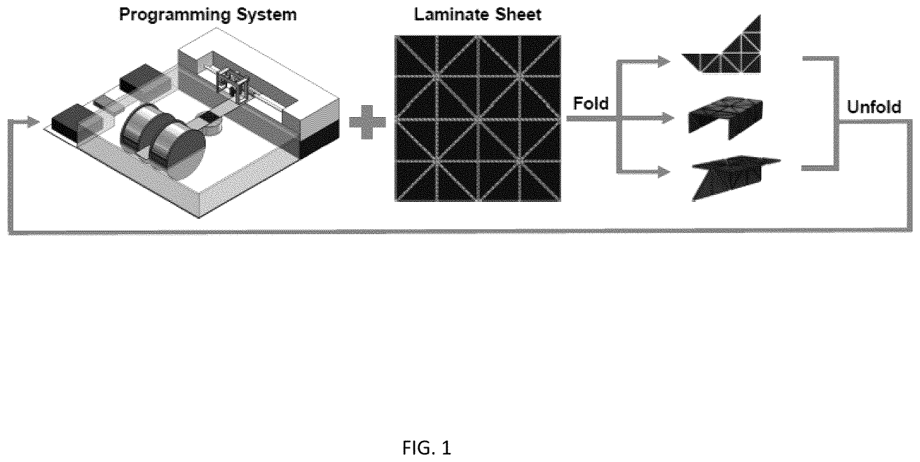

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below; although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s).” “include(s),” “having.” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value: they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including.” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

### Magnetically-Directed Configuration Changes

Recent advances in digital fabrication have enabled increasing complex structures to be manufactured automatically and on-demand. While technologies such as 3D printing have produced a large diversity of structures in an increasing variety of materials, not all geometries are able to be printed and the resulting shapes are often static and difficult to recycle. 4D printing, where the printed materials incorporate active materials [Leist et al. 2017; Rastogi and Kandasubramanian 2019; Tibbits 2014], provide printed structures with the ability to morph after printing and expand the space of printable geometries. These systems add a time change element under an external stimulus such as heat [Ding et al. 2017; Ge et al. 2013], light [Yang et al. 2017], moisture [Tahouni et al. 2020], or a prestressed substrate [Pérez et al. 2017]. Sequential shape changes can even be achieved by using multiple materials with different activation signals or thresholds, for example activating at different temperatures [Yu et al. 2015]. However, reusing the material in these 3D printed structures remains labor intensive, or near impossible for multi-material prints, and while limited recyclability has been demonstrated for 4D printed material [Li et al. 2019], this method requires the samples to be broken into smaller pieces manually along with additional processing over the course of over 20 hours.

A different approach towards on-demand fabrication is the idea of programmable matter. Programmable matter are systems with the ability to change their shape or mechanical properties in a controllable manner [Hawkes et al. 2010]. Reprogrammable matter can additionally specify and change their morphing capabilities on demand. The ability to change morphology provides a machine with adaptability and robustness and a potential for more efficient task execution if a good morphology can be achieved [Mintchev and Floreano 2016]. However, these systems require a tight integration of mechanical structure, sensing, actuation, and control to enact such a change consistently and robustly over a variety of desired geometries and configurations [Yang et al. 2018]. Recent advancements in mechanisms and materials have produced self-assembling and self-reconfigurable structures that are able to change their shape [Lee et al. 2017], morphology [Belke and Paik 2017; Daudelin et al. 2018], texture [Pikul et al. 2017], color [Alexander et al. 2018: Kim et al. 2021], or mechanical properties such as stiffness [Mintchev et al. 2018] and damping. However, while these materials systems have been successfully demonstrated on a wide range of shapes with complex kinematics, as yet, they still lack execution-time versatility. That is, the morphing transformation enacted by these systems are determined upon fabrication, and thus, the ability to reprogram the system to achieve different configurations as needed is lost.

In this disclosure, we present an autonomous system for real-time reprogrammability of self-assembling, shape-changing, and reusable structures. The work combines ideas in a programmable matter with a digital magnetic writing system to produce custom folded 3D structures within a few hours. In particular, we extend magnetic writing techniques to encode programming sequences for making 3D structures, triggered by localized external magnetic fields. By designing the magnetic program at the pixel level, we are able to control how the sheet responds to an external magnetic field. By reprogramming the sheet with a different magnetic program, we also show that the system can achieve both assembly into a folded shape and disassembly back to a flat sheet over multi-step fold sequences and over hundreds of programming cycles. The resulting system provides distinct advantages compared to existing self-folding approaches in its ability to generate virtually any folding sequence, and opens the way for new advancements in custom fabrication of reusable and refoldable parts.

Origami-Inspired Design. Origami-inspired fabrication is a widely accepted approach to creating thin, lightweight, and strong transformable structures [Filipov et al. 2015: Rus and Tolley 2018: Whitney et al. 2011]. Folded designs can be instantiated at meters [Melancon et al. 2021] to nanometers [Miskin et al. 2020] and serve in a variety of roles, from structural load bearing [Mintchev et al. 2018] and high power transduction [Chen et al. 2020] to supporting motion as a kinematic mechanism [Nelson et al. 2019] or vehicle for geometric change [Yang et al. 2021] and to computational storage and logic [Treml et al. 2018]. These structures use planar digital fabrication technologies with the ability to manufacture at large scales without losing functional complexity [Li et al. 2017; Sung and Rus 2015; Zhakypov et al. 2019] and can, in some cases, be designed algorithmically to produce desired motions or force response [Chen et al. 2022]. Further, integrating actuation directly into the fold pattern creates active structures with the ability to self-assemble [Felton et al. 2014; Liu et al. 2020]. However, most of these systems can only fold into one shape and cannot be reshaped or reused for other applications.

Programmable Matter and Reconfigurable Robots. Programmable matter systems attempt to achieve universal reconfiguration and recyclability through a large number of often homogeneous modules that combine together to form more complex structures. For example, large numbers of cubes may attach and detach magnetically [Davey et al. 2012: Gilpin et al. 2010], mechanically [Belke and Paik 2017], or fluidically [Tolley and Lipson 2011] to form voxelized shapes. Targeted reconfiguration into a particular shape is enabled by adding heterogeneity, for example changing the pattern of magnetization on magnetic units [Nisser et al. 2022].

Origami has also appeared in reconfigurable robots, often with a similar modular strategy. For example, the Kinetogami system [Gao et al. 2013] uses tetrahedral modules connected in loops to generate a wide variety of polyhedral structures, some of which have been actuated [Gao et al. 2014] to produce reconfigurable legged robots with changeable gaits. Systems using active computation and directed actuation for folding control [Felton et al. 2014; Hawkes et al. 2010] are able to generate folded shapes over multiple folding steps. At the extreme of this approach are modular systems such as Mori [Belke and Paik 2017], where triangular faces are able to attach and detach and fold along their attachment hinges to create structures of arbitrary complexity. While useful, these approaches require actuators on almost every fold to achieve truly universal reprogrammability and are thus inefficient in mass and space.

Magnetic Self-Assembly. In materials systems, magnetic control is one of many methods used for self-folding. Other common control signals such as temperature [Miyashita et al. 2017], diffusion [Na et al. 2015], and capillary forces [Rogers et al. 2016] often require long wait times for the signal to dissipate (e.g., for the sample to cool down or dry off), which makes repeated folding and unfolding challenging. Faster methods using chemical [Leong et al. 2009], electrochemical [Miskin et al. 2020], or light [Liu et al. 2017] signals require the desired folding sequence to be fabricated directly into the sheet and are thus difficult to reprogram into different structures.

In contrast, magnetic actuation offers a simple option for fast, reprogrammable shape change simply by applying a magnetic external field to a precisely-oriented magnetized sample. Previous approaches to magnetic self-assembly have not yet achieved full reprogrammability. Techniques using direct ink writing [Kim et al. 2018], lithography [Dong et al. 2022], and magnetically embedded elastomers [Tang et al. 2021: Yi et al. 2022: Zhang et al. 2021] require precise placement of particles with known magnetic polarity. As a result, the fold pattern and the behavior of individual folds are determined during fabrication, making it difficult to reprogram the structure to reconfigure into a different shape without manual human labor. In general, reconfigurability is achieved by adding another signal. For example, [Wu et al. 2021] took advantage of the twisting motion of a Kresling assembly to expand or compress different regions using a uniform magnetic field, simply by manipulating the direction of the field each region responds to. Work in [Song et al. 2020] achieved limited reprogrammability by heating up the entire structure to completely deprogram it and then remagnetizing the structure when it is in its desired shape. However, this process requires the structure to achieve the desired shape pre-magnetization and thus has limited applications to self-reconfigurability. Similarly, folds can also be generated on the fly using a combination of magnetization and light-responsive shape-memory polymers [Ha et al. 2021]. Since the material's response to an external field is fixed and the system can only activate or deactivate folding in particular areas using the light source, the complexity of the resulting structures that can be achieved is also limited.

### Contributions

The disclosed system advances beyond existing approaches in origami-inspired reconfiguration to generate self-assembling and self-folding structures using a uniform digital program-and-fold process. We combine the high controllability of electromechanical systems with the lightweight flexibility of materials systems to generate magnetically foldable structures that are customizable and reprogrammable at pixel resolution. In some embodiments, we use a magnetic write head that programs a thin magnetic sheet with North or South signals at the pixel level. This approach provides not only the basic ability to write and read the magnetic program written onto the sheet, but also, if the sheet is flexible enough, to manipulate and fold the sheet in arbitrary ways by applying an external magnetic field.

The contributions of this disclosure include:
an end-to-end approach to fabrication, programming, self-assembly, and reprogramming of magnetic folded structures;
an automated system for programming and assembly of a given fold pattern;
experimental verification showing that the system is capable of multi-step folding sequences, including both folding and unfolding steps, over hundreds of programming cycles;
a demonstration of how electronics can be incorporated into the sheet to produce a functional structure such as a foldable display as well as a demonstration of how different material compositions can be used to change the strength of the structure.

### Example System Overview

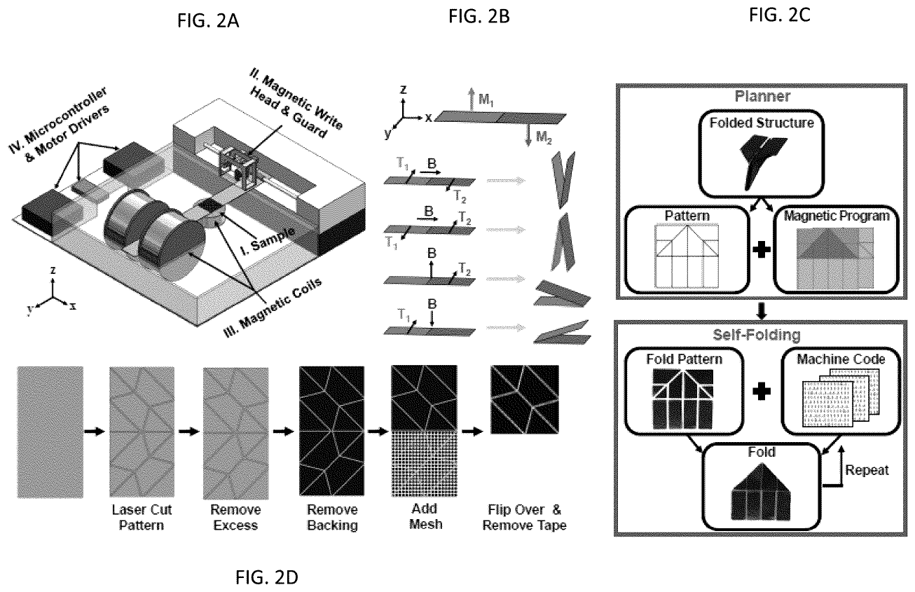

Our magnetic reprogrammable matter system consists of four main components (FIG. 2). The first component is the self-folding magnetic laminate sheet. The sheet is programmed to self-fold into a desired shape using the second component, a magnetic programming head that writes the magnetic polarity of the sheet at pixel resolution. Once the sheet is programmed, large external electromagnetic coils, the third component, produce a magnetic field across the sheet and generate the forces required for self-folding. The system is supported by the fourth component, algorithms and a graphical user interface that convert a desired magnetic program into fabrication drawings and machine instructions.

### Fabrication of the Magnetic Laminate Sheet

Our self-folding structure is a magnetic 3-layer laminate sheet constructed via a semi-automated process. The layers of the laminate are cut and aligned using the following steps (FIG. 2D). First, a thin sheet of magnetic material (0.3 mm thick X-Bet Ultra Thin Magnetic Sheet with Adhesive Backing) is adhered to three layers of tape (FROGTAPE 280222) with the adhesive side up. The faces of the desired fold pattern are then laser micromachined with a CO2 flatbed laser cutter (Universal Laser System PLS 4.75), choosing settings that cut through the magnetic material but not through the painter's tape. For our system, the following settings were used: for the pattern outline, 8% power, 2% speed, 1000 pulses per inch; for the fold lines, 6% power, 10% speed, 1000 pulses per inch.

The magnetic material in the folds and around the boundary of the pattern is then removed manually using tweezers. The adhesive backing on the remaining faces is also exposed by removing the protective film. Next, one layer of 0.1 mm thick polyester mesh (100% polyester diamond mesh tulle) is placed onto one side of the pattern and the sheet is folded in half. This step aligns the two mirror-image patterns cut into the magnetic film and adheres the faces to each other to keep the polyester mesh in place. The painter's tape backing is removed, leaving only the magnetic and mesh layers. The resulting pattern has thick magnetic material only on the faces and thin, flexible mesh at the folds, enabling the pattern to fold easily along the desired fold lines.

The vector drawing used to cut the faces is generated automatically from the original fold pattern; for custom one-off fabrication, this fold pattern will exactly correspond to the final desired shape. The fold pattern can also be a universal fold pattern, in which case it can be programmed to achieve multiple different shapes. The fabrication process requires only planar processes and can be automated using existing large-scale roll-to-roll manufacturing processes. For centimeter-scale models, the entire process takes less than 20 minutes.

### Magnetic Write Head for Magnetically Programming the Sheet

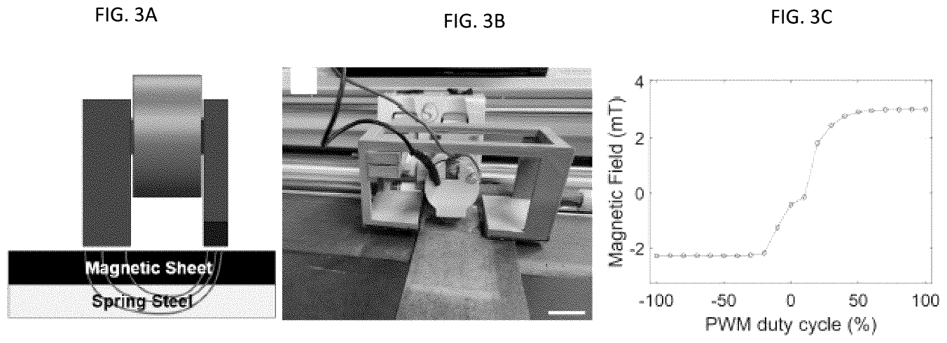

The second component and the key element required for reprogrammability in the self-folding system is a magnetic write head that programs custom folding sequences at the pixel level (FIG. 3). A digital write head translates over the top surface of the programmable sheet and programs rectangular pixels of magnetic North, South, or Clear (zero magnetic signal). A layer of spring steel under the sheet focuses the magnetic field and ensures approximately uniform magnetic field direction over the entire contact surface.

An example digital write head include an electromagnetic coil with 350 turns of 24 AWG enameled copper wire wrapped around a U-shaped core machined from 93% iron (FIG. 3A). The coil is powered at 30 V and 3.1 A. The electromagnet is controlled using a SmartDriveDou MDDS30 30A motor driver and an Arduino Uno, which set the PWM duty cycle (magnetic field strength) and direction (N or S) of the write head.

The write head core has a nonconstant cross-sectional area, being narrower (5 mm×5 mm) on the writing side and wider (10 mm×10 mm) on the other. With this configuration, the head produces concentrated 250 mT magnetic flux density on the narrow end that is strong enough to magnetize the sheet, while magnetic flux density on the wide end is only 50 mT, small enough not to overwrite the sheet even when passing over it. As a result, the program on the programmable sheet remains protected throughout the writing process, and the head can be used to write pixels at arbitrary locations as needed.

We determined experimentally that the minimum field required to magnetize the sheet is 50 mT, and a field strength of 200 mT completely saturates the magnetic material with a magnitude of 3.3 mT. The relationship between the field produced by the write head and the resulting surface field programmed onto the pattern is shown in FIG. 3C.

Movement is generated by mounting the write head on rails, in our case a Cameo Silhouette 3 vinyl cutter, which provides X-direction translation of the head on a linear rail and Y-direction translation through rollers that move the sheet material. The rails translate the write head step-wise over the surface of the sheet, at each pixel location turning on the electromagnetic coil and writing the correct polarity. The system is controlled using a Python driver that moves the head to a desired (x,y) coordinate with 0.05 mm resolution and activates the write head. The system is able to write at a speed of 2 s per pixel, limited only by the speed of the vinyl cutter used in our setup. For neighboring pixels, the system requires 1 s for movement and 1 s for writing. Incorporating feedback on the position of the write head could speed up the writing process.

To prevent misalignments due to the pattern sticking to the write head, we add a plastic guard to press the pattern downward during the writing process. The guard is a 3D printed frame with a sheet of clear 0.127 mm thick PET film (McMaster part 8567K54) glued underneath and is shown in FIG. 3B. The frame is mounted to the vinyl cutter and moves with the write head. When programming a pixel, the system first lowers the magnetic guard, then the write head is turned on. After programming, the write head turns off then the guard lifts, and then the system moves to the next writing location.

### Underlying Mechanisms of Magnetic Self-Folding

Self-folding in this system is the result of magnetic torque produced in each face through interactions between the magnetic pixels programmed onto the reprogrammable sheet and the magnetic field produced by large external electromagnetic coils (the third component). Consider a fold pattern that is programmed with pixels p_{x,y}, where each pixel p_{x,y} is a rectangle with fixed size (uniform across the entire sheet) centered around the coordinate (x,y). The pixel p_{x,y} is programmed with m_{x,y}=m_{x,y}\hat{z}, where the magnitude m_{x,y} ∈[−mₘₐₓ, mₘₐₓ] is the magnetic intensity (per unit area) programmed into the pixel.

For a face fi on the pattern, the total magnetic polarity Mᵢ is then

$${M}_{i} = {\sum }_{x , y} {m}_{x , y} \cdot A ( {p}_{x , y} ∩ {f}_{i} ) \qquad ( 1 )$$

that is the weighted sum of magnetic pixels in the face, where A(p_{x,y}∩fᵢ) is the area of the intersection between the pixel and the face. When an external field is applied via the large coil, the face aims to align itself with the direction of the applied field according to

$${T}_{i} = {M}_{i} \times B \qquad ( 2 )$$

where B is the magnetic field produced by the large coil and Ti is the magnetic torque induced on the face.

When neighboring faces are programmed with different magnetic polarities, the differing relative torques force the faces to fold relative to one another. Applying different directions of external fields results in different folding results as depicted in FIG. 2B.

### Magnetic Coils for Folding

In our system, external, near-constant magnetic fields are produced using large magnetic coils that surround the programmed sheet. When these coils are turned on, the resulting torques on each of the faces of the sheet cause the sheet to fold in less than 150 ms. If the program on the sheet is designed properly, the magnetized faces fold under the magnetic field and then snap together as the magnetic faces are attracted to each other, allowing the structure to maintain its shape once the external magnetic field has been removed, even without additional latches required in systems such as [Felton et al. 2014; Hawkes et al. 2010]. Our system includes two magnetic coils as shown in FIG. 2A:
(1) A pair of X-direction coils with 450 turns of 18 AWG enameled copper wire each around an iron core. At 6 A (30 V), the coil produces a maximum field of 26.2 mT. The two coils are placed on either side of the fold pattern.
(2) A single Z-direction coil with 350 turns of 18 AWG enameled copper wire with no iron core. At 6 A (30 V), the coil produces a maximum field of 19.6 mT. The coil is placed underneath the platform holding the fold pattern.

For self-folding, the magnetically programmed fold pattern is slid automatically into the coil workspace using the rollers on the vinyl cutter. The coils are controlled using SmartDriveDou MDDS30 30A motor drivers and an Arduino Uno.

### Converting Fold Patterns to Machine Code

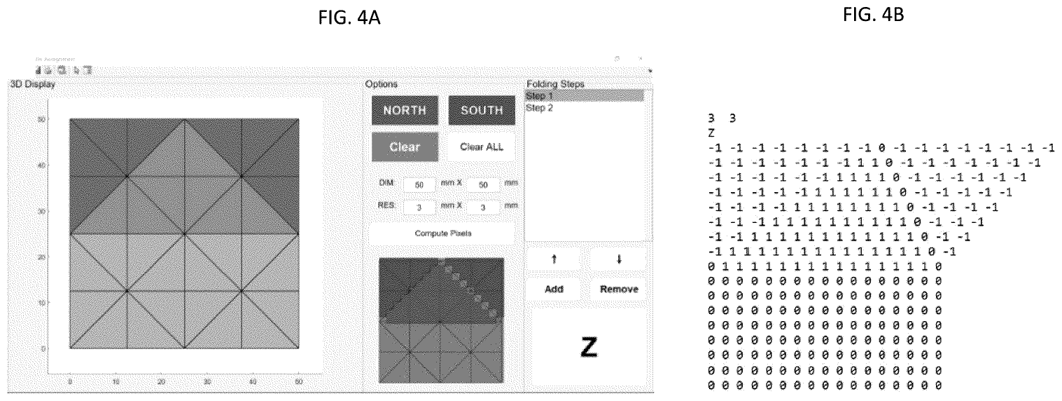

The system includes software (FIG. 2C) that converts a desired magnetic folding sequence into machine instructions. These steps include converting a desired fold pattern and folding sequence into fabrication drawings for the 3-layer laminate and a sequence of movement and writing steps for the magnetic write head. These steps have been implemented in MATLAB and incorporated into a graphical user interface (FIG. 4) for intuitive design of the programmable film. Once the sheet is fabricated, the system iteratively programs the sheet with a magnetic program, then submits the sheet to the appropriate coil for folding, before moving on to the next folding step. The process is fully automated once the programmable sheet is inserted. The total time required for self-folding depends on the complexity of the fold sequence and the resolution of the magnetic program.

Cut Pattern for Laminate Sheets. In order to convert the user-inputted fold pattern into a fabrication plan for the equivalent magnetically programmable sheet, the system starts with a simple polygon that has the same boundary as the desired fold pattern. Then, each of the folds in the desired pattern is thickened to a given fold width and the corresponding material is subtracted from the polygon in sequence. In our system, a fold width of 1.25 mm was chosen for all samples. However, this width may be changed depending on the materials, layer thicknesses, and the size of the pattern. In particular, smaller faces often require smaller fold widths so that the remaining material on the magnetic layers is not too small. In addition, differences in fold width between the top and bottom layer can be added to bias folding towards one direction, as has been used in previous self-folding fabrication approaches [Miyashita et al. 2015]. The process of subtracting material at the folds results in a number of disconnected faces that have been shrunk from their original shapes. Interior faces will have been shrunk on all sides by half of the fold width, while faces on the boundary will have been shrunk only on interior sides, leaving boundary dimensions intact. As a final step, to simplify alignment between layers, the entire sheet is mirrored over one of the boundary edges. The resulting design is directly outputted as a DXF to be sent to the laser cutter.

Machine Code for Pixel-wise Magnetization. Desired folds are programmed into the sheet as magnetic pixels. For now, to convert the desired magnetic program into writing instructions for the system, we rely on the user to specify the polarities of each face and the direction of the external magnetic field, although future work could incorporate strategies to automatically assign magnetization to individuals faces for a desired folding motion [Wang et al. 2021]. Using the graphical user interface, the user selects faces on the pattern and assigns them to be “North,” “South,” or “Clear.” Once the user also chooses a resolution for the program, the pixelated pattern is computed directly from the user's face assignment.

In particular, let μ(x,y)∈[−1, 1] be the assigned magnetization of the point (x,y) in the pattern, where μ(x,y)=1 indicates that the point lies within a face that has been assigned North, μ(x,y)=−1 indicates a South face, and μ(x,y)=0 indicates a Clear face. Values between these extremes may also be assigned if the user would like certain faces to react less strongly to the external magnetic field.

Now, consider a particular pixel px,y with user-defined dimensions Δx and Δy. The value mx,y programmed into this pixel is computed as

$${m}_{x , y} = ( \frac{{m}_{m a x}}{Δ x \cdot Δ y} ) ( {\int }_{y − \frac{Δ y}{2}}^{y + \frac{Δ y}{2}} {\int }_{x − \frac{Δ x}{2}}^{x + \frac{Δ x}{2}} μ ( x , y ) dxdy ) \qquad ( 3 )$$

that is the average magnetization of the area contained within the pixel.

The resulting matrix and associated resolution are written to a text file as shown in FIG. 4B. The first line of the file contains two values indicating the resolution Δx and Δy of the program. The second line indicates which electromagnetic coil (X or Z) to use for folding. The third line and on contains the space-delimited matrix of m_{x,y} values computed, arranged from left to right in increasing x and top to bottom in increasing y.

Multiple Folding Steps. Multi-step folding is achieved using a sequence of programming and folding steps. In this case, each step is written to a separate file, and one additional header file is generated, which contains the names of the individual step files in the order they should be executed. This representation creates a modular and extensible system with the ability to program folding sequences of arbitrary length and complexity. In programming steps after the first one, the system may be sped up by comparing magnetization matrices corresponding to the current step and the previous one and only writing over pixels that have changed values, taking into account that some portions of the material have folded and therefore multiple layers of material may exist.

### Resolution and Repeatability of Magnetic Programming

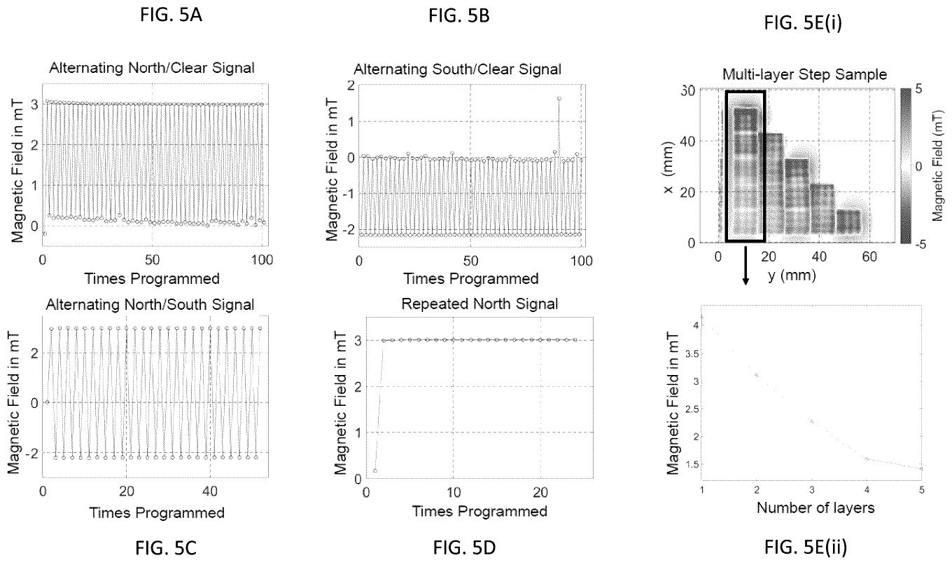

Repeated Writing. In order to reuse the sheet or for multi-step folding sequences, the sheet must be able to be reprogrammed consistently and repeatedly. A 10 mm×10 mm single layer of the magnetic sheet was cut, programmed, and then its surface magnetic field was imaged using a magnetic reader consisting of a MLX90393 magnetometer mounted to the same linear rails as the write head. FIG. 5 shows the results for repeated programming over multiple writing sequences, including (A) alternating North and South, (B/C) alternating North/South and Clear, and (D) repeated North. The results show that the sheet can be programmed over hundreds of cycles with no loss in the magnitude of the surface magnetic field and that the sheet can be reliably programmed both with North and South pixels and deprogrammed to have near-zero remnant magnetism.

Multi-Layer Tests. For multi-step folding sequences, it is also necessary to sometimes write through multiple layers of the magnetic sheet. A 50 mm×50 mm single layer of the magnetic sheet was cut into a step shape (FIG. 5E). The sample was folded four times to form a single column of five 10 mm×10 mm squares with thicknesses varying from 0.7 mm (one layer) at the top to 3.5 mm (five layers) at the bottom. The entire sample was programmed with a North signal, then the sample was unfolded manually and imaged.

Programming multiple layers of material simultaneously produces a nonuniform magnetic strength through the layers, with the strongest signal on the top layer and steadily decreasing magnetic field strength in lower layers. FIG. 5E (ii) shows the average surface field strength of each pixel row in the first column of the unfolded sample. X values between 2.5 mm and 12.5 mm correspond to five layers, 12.5 mm to 22.5 mm to four layers, and so on. While there is a large drop in magnetic field strength between one layer and two layers, the magnetic field strength seems to settle at around 2 mT by the time four or more layers are used. We suspect the drop in magnetic field strength for larger numbers of layers may be due to the air gap introduced on the non-writing end of the magnetic write head when the thickness of only the portion of the sample to be written is increased, but additional evaluation must be completed to verify whether this is the case.

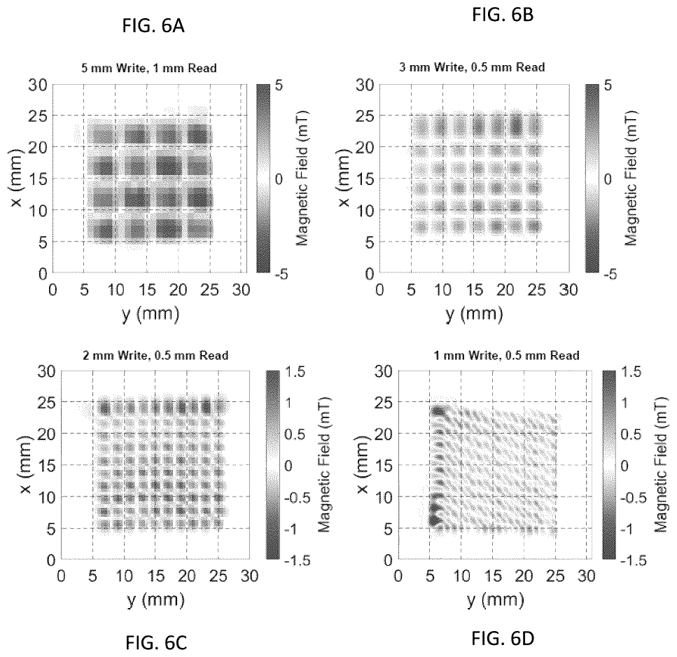

Resolution Tests. Although the writing end of the write head is 5 mm×5 mm, the resolution of the magnetic program can be chosen by the user. The system creates smaller pixels by writing a 5 mm×5 mm block, shifting by the desired amount, and then overwriting with a different value. To evaluate the adjustable resolution of the write head, we fabricated a 20 mm×20 mm square sheet with no folds. We then programmed checkerboard patterns of alternating North and South pixels with different pixel sizes and imaged the result. For the last pixel of each row and column, the overflow was rewritten with a Clear signal. Magnetic images for the 5 mm resolution, 3 mm resolution, 2 mm resolution, and 1 mm resolution tests are shown in FIG. 6. The minimum programming resolution is subject to the accuracy of the linear rails. The maximum strength of the magnetic field measured on the surface of the sheet decreases with higher resolution due to fringe fields from neighboring pixels, but the checkerboard pattern is clear for the 2 mm and larger checkerboard patterns.

### Single-Step Folding

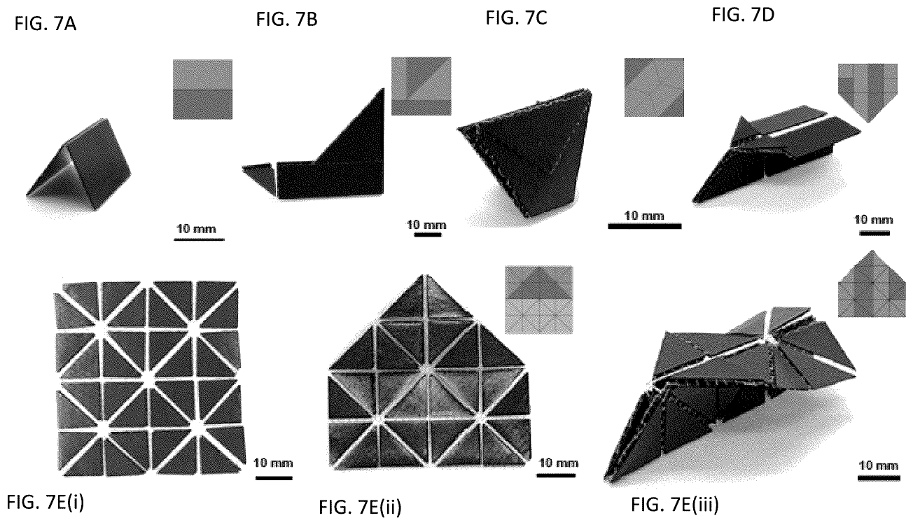

We demonstrate the versatility of our system by fabricating a variety of fold patterns at several resolutions and scales. FIG. 7 shows examples of the range of patterns that can be produced. Using the insights from our initial benchmarks, we designed and programmed common-fold patterns aimed at exposing different capabilities of the system.

Book Fold and Scalability. The book fold (FIG. 7A) is the simplest fold pattern with two rectangular faces. When the two faces are programmed with opposite polarity, the pattern folds along the centerline. However, even within this seemingly simple design, the direction of folding can be precisely controlled by changing the direction of the externally applied magnetic field (FIG. 2B). As a result, the system is able to produce both mountain and valley folds, as well as patterns that fold into either the vertical or the horizontal plane.

We fabricated book fold patterns in 8 different sizes ranging in dimensions from 10.24 mm×10.24 mm to 48.8 mm×48.8 mm, all programmed at a pixel resolution of 3 mm. Each sample took 5 min. to fabricate. The smallest sample required 1 min to program, and the largest required 10 min. The resulting samples weighed 0.12 g to 2.8 g. All samples were self-folded with the X coils using a magnetic field of 22.7 mT. All samples were able to be programmed and self-fold with a 100% success rate over 3 trials. The maximum size of the foldable pattern is limited by the strength of the magnetic field produced by the external coils, and the minimum size is limited by the inherent stiffness of the mesh layer of the sheet.

We additionally demonstrated simultaneous programming and folding of an array of samples, illustrating the system's scalability not only in structure size but also quantity. We fabricated 18 of the 10.24 mmx 10.24 mm book fold patterns and laid the samples in a 6×3 array with a total size of 42.5 mm×86.64 mm. We then instructed the system to program the array as a single set and fold the samples in the X coils under a magnetic field of 22.7 mT. The samples took 10 min. total to fabricate and 3 min. total to program. All 18 samples folded successfully into the vertical plane. Using this parallel programming and folding process, future manufacturing systems may be able to mass produce custom folded structures as quickly as 1 min. per sample.

Load Tests. We used two patterns to conduct load tests and evaluate the utility of our programmable sheet for carrying additional components.

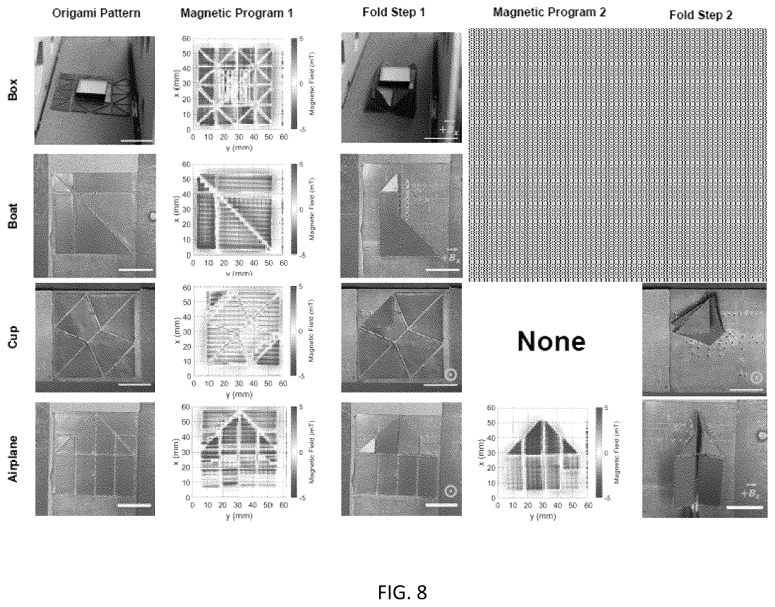

For each pattern, we tested the “dead lift” capacity, which was measured by placing square stacks of increasing weight on the programmable sheet until it was unable to fold. Successful actuation was defined as being able to fold completely to full height. First, we tested the box pattern (FIG. 8, row 1). The measured deadlift capacity was 2.7 g, which corresponds to 1.35 times the weight of the sample. Secondly, we texted 10.24 mm×10.24 mm book folds arranged in a 6×3 array. The samples were able to lift a weight of 13.7 g. which corresponds to 0.95 times the combined weight of the samples. Together, these tests indicate that the self-folding sheet should be able to support additional non-magnetic components such as electronics, sensors, or actuators, which could be used to add functionality for future self-reconfiguring robots or other active structures.

Single-Step Boat. The boat (FIG. 7B) is a flat-foldable pattern with 6 faces and 6 folds. The faces range in size from large 35.9×35.9 mm isosceles right triangles forming the sail to small 10.9×10.9 mm isosceles right triangles forming the bow. Complete fabrication time included 1 min. laser cutting and 7 min. manual layer alignment and assembly. The final sample weighs 2.4 g and is shown in FIG. 8 (row 2).

Programming the sails with opposite magnetic polarity to the hull produces an inside reverse fold with the sail oriented inside out compared to the hull and demonstrates our system's ability to fold multiple sizes of faces and folds even within the same pattern. The entire programming and folding process takes approximately 10 min.

### Multi-Step Folding

For multi-step folding sequences, the system executes a sequence of program-then-fold steps, at each step producing a flat folded structure that can be reprogrammed for the subsequent steps. We demonstrate this capability on two patterns, each requiring two folding steps.

Two-Step Cup Pattern. The cup pattern (FIG. 7C) is a 50 mm×50 mm pattern with 8 faces and 9 folds. Complete fabrication time included 1 min. laser cutting and 6 min manual layer alignment and assembly. The final sample weighs 2.3 g and is shown in FIG. 8 (row 3). The pattern requires two folding steps but only one programming step, first folding the top left corner down and then the rest of the sample in half. The key here is that even with the same magnetic program written onto the sheet, folds can be actuated to fold in different directions by changing the direction of the external magnetic field, thus producing sequential folding without a reprogramming step. The sample was programmed at a resolution of 3 mm and folded using the Z coil. The entire process takes approximately 12 minutes.

Two-Step Airplane. The airplane pattern (FIG. 7D) is a 50 mm×50 mm pattern with 12 faces and 16 folds. Complete fabrication time included 1 min. laser cutting and 6 min. manual layer alignment and assembly. The final sample weighs 2.2 g and is shown in FIG. 8 (row 4). The pattern requires two folding steps and two programming steps. The first step is to fold the two top corners down using the Z coil. The second step is to fold the sample in half and the wings down using the X coil. The entire process takes approximately 10 min and demonstrates our system's ability to perform fully automated program-and-fold actions over multiple folding steps.

### Reconfigurability and Reprogrammability

Universal fold patterns such as the waterbomb tessellation [Hawkes et al. 2010] and the Miura-ori tessellation [Dudte et al. 2016: Silverberg et al. 2014] are known to be able to produce arbitrary shapes up to the resolution of the pattern. For example, both the airplane and boat examples above can be constructed using a 2×2 waterbomb tessellation. That is, the same fold pattern can be programmed with different magnetic programs to produce two different folded structures.

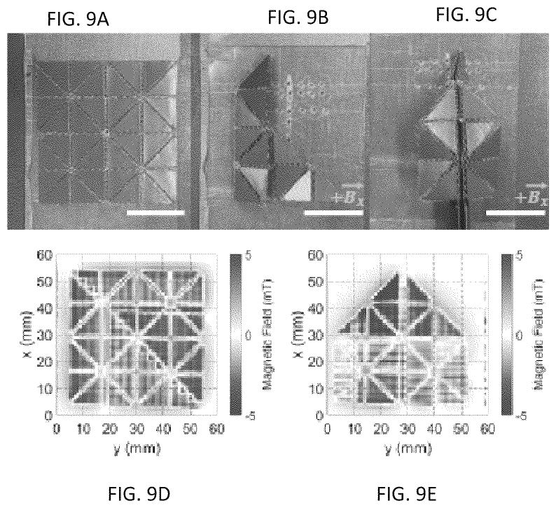

Achieving Multiple Shapes using a Universal Fold Pattern. To evaluate the versatility of the system and our ability to fold the same pattern in multiple ways, we constructed a universal fold pattern as shown in FIG. 9A. The pattern is a 50 mm×50 mm waterbomb tessellation with 2×2 units, for a total of 32 faces and 40 folds. Complete fabrication time included 1.5 min. laser cutting and 10 min. manual layer alignment and assembly. The final sample weighs 1.7 g.

The sample was programmed and folded using the same procedure as the regular boat and regular airplane structures (FIG. 7E). The entire process takes approximately 10 min for each one. During folding, we observed that the UFP samples fold more slowly than the original pattern-specific samples, likely because additional magnetic material is removed in the extra folds in the UFP as compared to the regular boat and airplane, thus reducing the magnetic torque on the faces. However, both shapes were able to be folded successfully from the same UFP pattern.

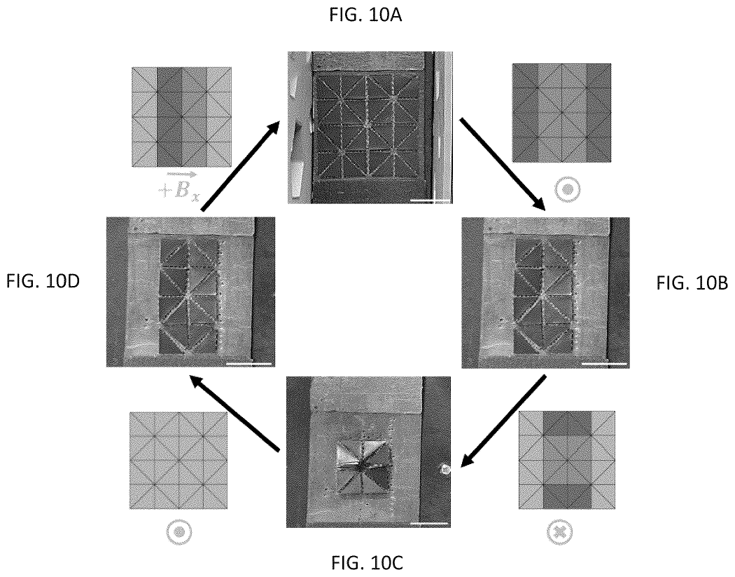

Folding and Unfolding the Box Pattern. In order for the programmable sheet to be reusable for multiple shapes, the system must have the ability to both fold and unfold a sample. We demonstrate a full assembly and disassembly sequence of a box on the 2×2 UFP (FIG. 10).

Folding the box requires 2 fold steps, which translates to 2 programming steps. In the first step, the pattern is programmed with North-polarity pixels in the middle two columns and South-polarity pixels on the outer two columns.

The Z coil is then used to fold both sides of the pattern and reduce the width of the pattern to half (FIG. 10B). In the second step, the pattern is folded in half again, this time in height (FIG. 10C).

Unfolding the box is the reverse of the folding procedure and requires 2 unfolding steps. Since the pattern is already magnetized, only 1 programming step is required. In the first step, the Z coil is used in the opposite polarity to undo the second folding step (FIG. 10D). In the second step, the sample is reprogrammed, and the X coil is used to unfold it into a flat sheet (FIG. 10A).

Each programming step was completed at a resolution of 3 mm. Programming required approximately 10 min. for folding step 1, 6 min. for folding step 2, and 6 min. for the unfolding step.

Foldable Display with Embedded Circuitry

Finally, we demonstrate how additional electronic components can be added to the self-folding sheet to add functionality. As determined during load tests, the pattern should be able to fold even with components adding weight up to the pattern's own mass.

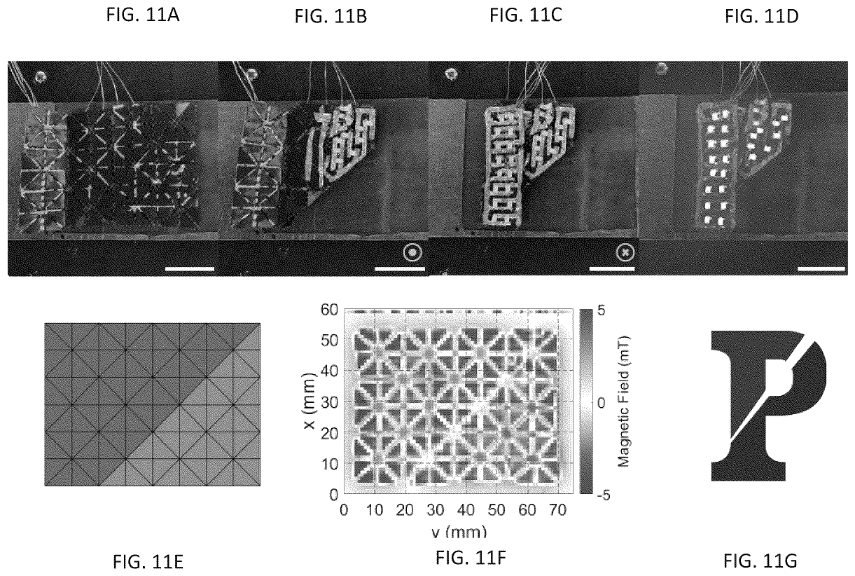

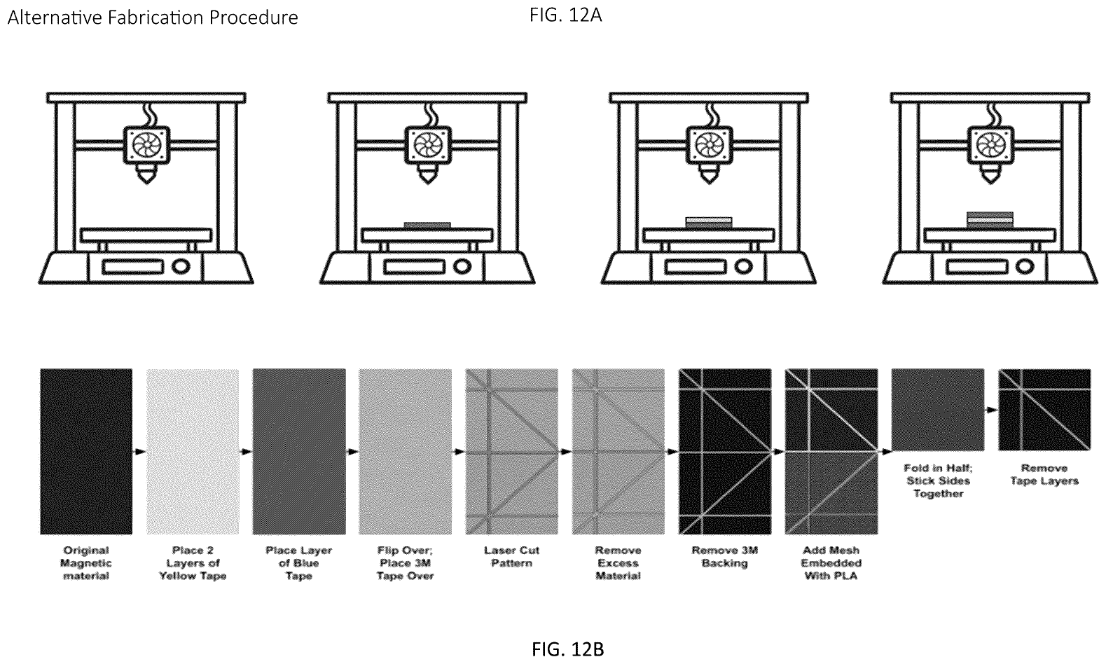

We, therefore, constructed a foldable display (FIG. 11) capable of folding into different shapes with light patterns. The foldable display is constructed as a 3×4 universal fold pattern with dimensions of 50 mm×67 mm and a 1.25 mm folding gap. After fabricating the 3-layer magnetic fold pattern using the standard process, electronic traces were cut out of adhesive-backed copper tape using the vinyl cutter and adhered manually to the sheet. Copper traces corresponding to 3.2 V and ground were adhered onto the top surface of the pattern in a comb pattern so that each of the triangular faces contain both a power and ground trace. Surface mount LEDs were then soldered manually on each of the faces of the fold pattern. In addition, 32 AWG wire was soldered on the edge of the pattern to connect power (3.2 V) and ground. Complete fabrication required 3 min. laser cutting, 30 min. manual layer alignment and assembly, broken down as 3 min. for cutting the copper traces, 2 min. for attaching the traces, and 25 min. for soldering the connections. The final sample weighs 1.8 g without electronics and 5.5 g with electronics

We test the display by folding it into the letter P, which then lights up after folding. Folding the pattern into a P requires two folding steps that can be combined into one programming step. The required magnetic program is shown in FIG. 11E. The sheet was programmed with a resolution of 3 mm.

In the first step, the coils apply a vertical magnetic field oriented in the South direction, causing the bottom right triangle of North-programmed faces to fold (FIG. 11B). In the second step, the external magnetic field changes to orient in the North direction, causing the left rectangle of South-programmed faces to fold (FIG. 11C). Since the right side of the pattern is weighed down by a double layer of sheet and electronics, it remains stationary even though its net polarity is also oriented North.

Once the folding is completed, leads are attached to the copper traces on the pattern and connected to an external power supply to power the LEDs and display the colored pattern (FIG. 11D). The entire programming and fold sequence takes approximately 17 min. The display was able to fold successfully in all of 3 trials.

### CONCLUSION

In this paper, we demonstrate an end-to-end system for fully reprogrammable sheets that self-reconfigure autonomously into multiple, complex 3D shapes using magnetically controlled origami. The system is able to achieve complex shapes over multi-step folding sequences over hundreds of programming cycles using a uniform program-and-fold process. The system provides precision and repeatability, enabling fold patterns to be magnetically programmed at the pixel level with millimeter resolution. The structures resulting from our system are recyclable and reprogrammable in that the sheets can self-unfold and their magnetic programs be rewritten to produce different structures altogether.

Zooming out, we expect that magnetic program-and-fold technology will enable new levels of complexity and customization for future reprogrammable matter. Although we have focused in this system on only rigidly foldable patterns where the bending of the sheet is localized at the folds, the same techniques can be applied to future applications requiring other types of sheet deformation, such as bending, torsion, or shear. Of course, realizing 3D structures using other types of deformation will require alternative ways to predict and secure the final 3D form. Further, by modulating the mechanical gantry system for faster write times, magnetic writing out of the plane, and incorporating feedback through sensing of an existing magnetic program, entire centimeter-scale structures can be produced within seconds.

Unlike many existing approaches to self-folding structures, which rely on torques applied at the folds [Felton et al. 2014: Hawkes et al. 2010], our system relies on forces and torques applied on the faces themselves. We have demonstrated in this paper that we are able to reproduce many of the shapes that have been generated by other self-folding systems. However, the extent to which these two modes of control differ is yet unclear. Extending work in theoretical self-folding [Liu et al. 2022: Tachi and Hull 2017] is required to more fully characterize the capabilities of this system.

Finally, we have demonstrated that it is possible to embed active components into the sheet. Future work will explore additional active components such as actuation, sensing, power, and communications to produce new structures with morphing capabilities wide range of applications.

### REFERENCES

Jason Alexander, Anne Roudaut, Jürgen Steimle, Kasper Hornbæk, Miguel Bruns Alonso, Sean Follmer, and Timothy Merritt. 2018. Grand challenges in shape-changing interface research. In Proceedings of the 2018 CHI Conference on Human Factors in Computing Systems. 1-14. https://doi.org/10.1145/3173574.3173873
Christoph H Belke and Jamie Paik. 2017. Mori: a modular origami robot. IEEE/ASME Transactions on Mechatronics 22, 5 (2017), 2153-2164.
Wei-Hsi Chen, Shivangi Misra, Yuchong Gao, Young-Joo Lee, Daniel E Koditschek, Shu Yang, and Cynthia R Sung. 2020. A programmably compliant origami mechanism for dynamically dexterous robots. IEEE Robotics and Automation Letters 5, 2 (2020), 2131-2137.
Wei-Hsi Chen, Woohyeok Yang, Lucien Peach, Daniel E Koditschek, and Cynthia R Sung. 2022. Kinegami: Algorithmic Design of Compliant Kinematic Chains From Tubular Origami. IEEE Transactions on Robotics (2022).
Jonathan Daudelin, Gangyuan Jing, Tarik Tosun, Mark Yim, Hadas Kress-Gazit, and Mark Campbell. 2018. An integrated system for perception-driven autonomy with modular robots. Science Robotics 3, 23 (2018), eaat4983.
Jay Davey, Ngai Kwok, and Mark Yim. 2012. Emulating self-reconfigurable robots-design of the SMORES system. In 2012 IEEE/RSJ International Conference on Intelligent Robots and Systems. 4464-4469. https://doi.org/10.1109/IROS.2012.6385845
Zhen Ding, Chao Yuan, Xirui Peng, Tiejun Wang, H Jerry Qi, and Martin L. Dunn. 2017. Direct 4D printing via active composite materials. Science Advances 3, 4 (2017). https://doi.org/10.1126/sciadv.1602890 Cited by: 440; All Open Access, Gold Open Access, Green Open Access.
Yue Dong, Lu Wang, Neng Xia, Zhengxin Yang, Chong Zhang, Chengfeng Pan, Dongdong Jin, Jiachen Zhang, Carmel Majidi, and Li Zhang. 2022. Untethered small-scale magnetic soft robot with programmable magnetization and integrated multifunctional modules. Science advances 8, 25 (2022), eabn8932.
Levi H Dudte, Etienne Vouga, Tomohiro Tachi, and Lakshminarayanan Mahadevan. 2016. Programming curvature using origami tessellations. Nature Materials 15, 5 (2016), 583-588.
Samuel Felton, Michael Tolley, Erik Demaine, Daniela Rus, and Robert Wood. 2014. A method for building self-folding machines. Science 345, 6197 (2014), 644-646.
Evgueni T Filipov, Tomohiro Tachi, and Glaucio H Paulino. 2015. Origami tubes assembled into stiff, yet reconfigurable structures and metamaterials. Proceedings of the National Academy of Sciences 112, 40 (2015), 12321-12326.
Wei Gao, Ke Huo, Jasjeet S. Seehra, Karthik Ramani, and Raymond J. Cipra. 2014. HexaMorph: A reconfigurable and foldable hexapod robot inspired by origami. In 2014 IEEE/RSJ International Conference on Intelligent Robots and Systems. 4598-4604. https://doi.org/10.1109/IROS.2014.6943214
Wei Gao, Karthik Ramani, Raymond J Cipra, and Thomas Siegmund. 2013. Kinetogami: A reconfigurable, combinatorial, and printable sheet folding. Journal of Mechanical Design 135, 11 (2013).
Qi Ge, H. Jerry Qi, and Martin L. Dunn. 2013. Active materials by four-dimension printing. Applied Physics Letters 103, 13 (09 2013), 131901. https://doi.org/10.1063/1.4819837arXiv:https://pubs.aip.org/aip/apl/article-pdf/doi/10.1063/1.4819837/14282919/131901_1_online.pdf
Kyle Gilpin, Ara Knaian, and Daniela Rus. 2010. Robot pebbles: One centimeter modules for programmable matter through self-disassembly. In 2010 IEEE International Conference on Robotics and Automation. 2485-2492. https://doi.org/10.1109/ROBOT.2010.5509817
Minjeong Ha, Gilbert Santiago Cañón Bermúdez, Jessica A.-C. Liu, Eduardo Sergio Oliveros Mata, Benjamin A. Evans, Joseph B. Tracy, and Denys Makarov. 2021. Reconfigurable Magnetic Origami Actuators with On-Board Sensing for Guided Assembly. Advanced Materials 33, 25 (2021), 2008751. https://doi.org/10.1002/adma.202008751arXiv:https://onlinelibrary.wiley.com/doi/pdf/10.100 2/adma.202008751
Elliot Hawkes, B An, Nadia M Benbernou, H Tanaka, Sangbae Kim, Erik D Demaine, D Rus, and Robert J Wood. 2010. Programmable matter by folding. Proceedings of the National Academy of Sciences 107, 28 (2010), 12441-12445.
Shun-ichi Iwasaki. 1984. Perpendicular magnetic recording-Evolution and future. IEEE Transactions on Magnetics 20, 5 (1984), 657-662.
Hyeonseok Kim, Joonhwa Choi, Kyun Kyu Kim, Phillip Won, Sukjoon Hong, and Seung Hwan Ko. 2021. Biomimetic chameleon soft robot with artificial crypsis and disruptive coloration skin. Nature communications 12, 1 (2021), 1-11.
Yoonho Kim, Hyunwoo Yuk, Ruike Zhao, Shawn A. Chester, and Xuanhe Zhao. 2018. Printing ferromagnetic domains for untethered fast-transforming soft materials. Nature 558, 7709 (2018), 274-279. https://doi.org/10.1038/s41586-018-0185-0
Dae-Young Lee, Sa-Reum Kim, Ji-Suk Kim, Jae-Jun Park, and Kyu-Jin Cho. 2017. Origami wheel transformer: A variable-diameter wheel drive robot using an origami structure. Soft Robotics 4, 2 (2017), 163-180.
Steven K. Leist, Dajing Gao, Richard Chiou, and Jack Zhou. 2017. Investigating the shape memory properties of 4D printed polylactic acid (PLA) and the concept of 4D printing onto nylon fabrics for the creation of smart textiles. Virtual and Physical Prototyping 12, 4 (2017), 290-300. https://doi.org/10.1080/17452759.2017.1341815 arXiv:https://doi.org/10.1080/17452759.2017.1341815
Timothy G Leong, Christina L Randall, Bryan R Benson, Noy Bassik, George M Stern, and David H Gracias. 2009. Tetherless thermobiochemically actuated microgrippers. Proceedings of the National Academy of Sciences 106, 3 (2009), 703-708.
Ang Li, Adithya Challapalli, and Guoqiang Li. 2019. 4D Printing of Recyclable Lightweight Architectures Using High Recovery Stress Shape Memory Polymer. Scientific Reports 9, 1 (May 2019). https://doi.org/10.1038/s41598-019-44110-9
Shuguang Li, Daniel M Vogt, Daniela Rus, and Robert J Wood. 2017. Fluid-driven origami-inspired artificial muscles. Proceedings of the National academy of Sciences 114, 50 (2017), 13132-13137.
Addison Liu, Mykell Johnson, and Cynthia Sung. 2022. Increasing Reliability of Self-Folding of the Origami Hypar. Journal of Mechanisms and Robotics 14, 6 (2022), 061003.
Jiaqi Liu, Yuchong Gao, Young-Joo Lee, and Shu Yang. 2020. Responsive and foldable soft materials. Trends in Chemistry 2, 2 (2020), 107-122.
Ying Liu, Brandi Shaw, Michael D Dickey, and Jan Genzer. 2017. Sequential self-folding of polymer sheets. Science Advances 3, 3 (2017), e1602417.
David Melancon, Benjamin Gorissen, Carlos J García-Mora, Chuck Hoberman, and Katia Bertoldi. 2021. Multistable inflatable origami structures at the metre scale. Nature 592, 7855 (2021), 545-550.
Stefano Mintchev and Dario Floreano. 2016. Adaptive morphology: A design principle for multimodal and multifunctional robots. IEEE Robotics & Automation Magazine 23, 3 (2016), 42-54.
Stefano Mintchev, Jun Shintake, and Dario Floreano. 2018. Bioinspired dual-stiffness origami. Science Robotics 3, 20 (2018), eaau0275.
Marc Z Miskin, Alejandro J Cortese, Kyle Dorsey, Edward P Esposito, Michael F Reynolds, Qingkun Liu, Michael Cao, David A Muller, Paul L McEuen, and Itai Cohen. 2020. Electronically integrated, mass-manufactured, microscopic robots. Nature 584, 7822 (2020), 557-561.
Shuhei Miyashita, Steven Guitron, Shuguang Li, and Daniela Rus. 2017. Robotic metamorphosis by origami exoskeletons. Science Robotics 2, 10 (2017), eaao4369.
Shuhei Miyashita, Steven Guitron, Marvin Ludersdorfer, Cynthia R. Sung, and Daniela Rus. 2015. An untethered miniature origami robot that self-folds, walks, swims, and degrades. In 2015 IEEE International Conference on Robotics and Automation (ICRA). 1490-1496. https://doi.org/10.1109/ICRA.2015. 7139386
Jun-Hee Na, Arthur A Evans, Jinhye Bae, Maria C Chiappelli, Christian D Santangelo, Robert J Lang, Thomas C Hull, and Ryan C Hayward. 2015. Programming reversibly self-folding origami with micropatterned photo-crosslinkable polymer trilayers. Advanced Materials 27, 1 (2015), 79-85.
Todd G Nelson, Trent K Zimmerman, Spencer P Magleby, Robert J Lang, and Larry L Howell. 2019. Developable mechanisms on developable surfaces. Science Robotics 4, 27 (2019), eaau5171.
Martin Nisser, Yashaswini Makaram, Faraz Faruqi, Ryo Suzuki, and Stefanie Mueller. 2022. Selective Self-Assembly using Re-Programmable Magnetic Pixels. arXiv: 2208.03799 [cs.RO]
Jesús Pérez, Miguel A Otaduy, and Bernhard Thomaszewski. 2017. Computational design and automated fabrication of kirchhoff-plateau surfaces. ACM Transactions on Graphics (TOG) 36, 4 (2017), 1-12.
J H Pikul, S Li, H Bai, R T Hanlon, I Cohen, and Robert F Shepherd. 2017. Stretchable surfaces with programmable 3D texture morphing for synthetic camouflaging skins. Science 358, 6360 (2017), 210-214.
SN Piramanayagam. 2007. Perpendicular recording media for hard disk drives. Journal of Applied Physics 102, 1 (2007), 2.
Prasansha Rastogi and Balasubramanian Kandasubramanian. 2019. Breakthrough in the printing tactics for stimuli-responsive materials: 4D printing. Chemical Engineering Journal 366 (2019), 264-304. https://doi.org/10.1016/j.cej.2019.02.085
John Rogers, Yonggang Huang, Oliver G Schmidt, and David H Gracias. 2016. Origami MEMS and NEMS. MRS Bulletin 41, 2 (2016), 123-129.
Daniela Rus and Michael T Tolley. 2018. Design, fabrication and control of origami robots. Nature Reviews Materials 3, 6 (2018), 101-112.
Jesse L Silverberg, Arthur A Evans, Lauren McLeod, Ryan C Hayward, Thomas Hull, Christian D Santangelo, and Itai Cohen. 2014. Using origami design principles to fold reprogrammable mechanical metamaterials. Science 345, 6197 (2014), 647-650.
Hyeonseo Song, Hajun Lee, Jaebyeong Lee, Jun Kyu Choe, Suwoo Lee, Jee Yoon Yi, Sunghoon Park, Jung-Woo Yoo, Min Sang Kwon, and Jiyun Kim. 2020. Reprogrammable Ferromagnetic Domains for Reconfigurable Soft Magnetic Actuators. Nano Letters 20, 7 (June 2020), 5185-5192. https://doi.org/10.1021/acs.nanolett.0c01418
Cynthia Sung and Daniela Rus. 2015. Foldable joints for foldable robots. Journal of Mechanisms and Robotics 7, 2 (2015), 021012.
Tomohiro Tachi and Thomas C Hull. 2017. Self-foldability of rigid origami. Journal of Mechanisms and Robotics 9, 2 (2017), 021008.
Yasaman Tahouni, Tiffany Cheng, Dylan Wood, Renate Sachse, Rebecca Thierer, Manfred Bischoff, and Achim Menges. 2020. Self-Shaping Curved Folding: A 4D-Printing Method for Fabrication of Self-Folding Curved Crease Structures. In Proceedings of the 5th Annual ACM Symposium on Computational Fabrication (Virtual Event, USA) (SCF ′20). Association for Computing Machinery, New York, NY, USA, Article 5, 11 pages. https://doi.org/10.1145/3424630.3425416
Daofan Tang, Chengqian Zhang, Haonan Sun, Huangzhe Dai, Jun Xie, Jianzhong Fu, and Peng Zhao. 2021. Origami-inspired magnetic-driven soft actuators with programmable designs and multiple applications. Nano Energy 89 (November 2021), 106424. https://doi.org/10.1016/j.nanoen.2021.106424
Skylar Tibbits. 2014. 4D Printing: Multi-Material Shape Change. Architectural Design 84, 1 (2014), 116-121. https://doi.org/10.1002/ad.1710 arXiv:https://onlinelibrary.wiley.com/doi/pdf/10.1002/ad.1710
Michael T Tolley and Hod Lipson. 2011. On-line assembly planning for stochastically reconfigurable systems. The International Journal of Robotics Research 30, 13 (2011), 1566-1584. https://doi.org/10.1177/0278364911398160 arXiv:https://doi.org/10.1177/0278364911398160
Benjamin Treml, Andrew Gillman, Philip Buskohl, and Richard Vaia. 2018. Origami mechanologic. Proceedings of the National Academy of Sciences 115, 27 (2018), 6916-6921.
Liu Wang, Dongchang Zheng, Pablo Harker, Aman B Patel, Chuan Fei Guo, and Xuanhe Zhao. 2021. Evolutionary design of magnetic soft continuum robots. Proceedings of the National Academy of Sciences 118, 21 (2021), e2021922118.
John P Whitney, Pratheev S Sreetharan, Kevin Y Ma, and Robert J Wood. 2011. Pop-up book MEMS. Journal of Micromechanics and Microengineering 21, 11 (2011), 115021.
R. J. Wood, S. Avadhanula, R. Sahai, E. Steltz, and R. S. Fearing. 2008. Microrobot Design Using Fiber Reinforced Composites. Journal of Mechanical Design 130, 5 (03 2008). https://doi.org/10.1115/1.2885509 arXiv:https://asmedigitalcollection.asme.org/mechanicaldesign/article-pdf/130/5/052304/5923338/052304_1.pdf
Shuai Wu, Qiji Ze, Jize Dai, Nupur Udipi, Glaucio H. Paulino, and Ruike Zhao. 2021. Stretchable origami robotic arm with omnidirectional bending and twisting. Proceedings of the National Academy of Sciences 118, 36 (August 2021). https://doi.org/10.1073/pnas.2110023118
Guang-Zhong Yang, Jim Bellingham, Pierre E Dupont, Peer Fischer, Luciano Floridi, Robert Full, Neil Jacobstein, Vijay Kumar, Marcia McNutt, Robert Merrifield, et al. 2018. The grand challenges of Science Robotics. Science Robotics 3, 14 (2018), eaar7650.
Hui Yang, Wan Ru Leow, Ting Wang, Juan Wang, Jiancan Yu, Ke He, Dianpeng Qi, Changjin Wan, and Xiaodong Chen. 2017. 3D Printed Pho-toresponsive Devices Based on Shape Memory Composites. Advanced Materials 29, 33 (2017), 1701627. https://doi.org/10.1002/adma.201701627 arXiv:https://onlinelibrary.wiley.com/doi/pdf/10.1002/adma.201701627
Zhiyuan Yang, Dongsheng Chen, David J Levine, and Cynthia Sung. 2021. Origami-inspired robot that swims via jet propulsion. IEEE Robotics and Automation Letters 6, 4 (2021), 7145-7152.
Shengzhu Yi, Liu Wang, Zhipeng Chen, Jian Wang, Xingyi Song, Pengfei Liu, Yuanxi Zhang, Qingqing Luo, Lelun Peng, Zhigang Wu, Chuan Fei Guo, and Lelun Jiang. 2022. High-throughput fabrication of soft magneto-origami machines. Nature Communications 13, 1 (July 2022). https://doi.org/10.1038/s41467-022-31900-5
Kai Yu, Alexander Ritchie, Yiqi Mao, Martin L. Dunn, and H. Jerry Qi. 2015. Controlled Sequential Shape Changing Components by 3D Printing of Shape Memory Polymer Multimaterials. Procedia IUTAM 12 (2015), 193-203. https://doi.org/10.1016/j.piutam.2014.12.021 IUTAM Symposium on Mechanics of Soft Active Materials.
Zhenishbek Zhakypov, Kazuaki Mori, Koh Hosoda, and Jamie Paik. 2019. Designing minimal and scalable insect-inspired multi-locomotion millirobots. Nature 571, 7765 (2019), 381-386.
Jiachen Zhang, Ziyu Ren, Wenqi Hu, Ren Hao Soon, Immihan Ceren Yasa, Zemin Liu, and Metin Sitti. 2021. Voxelated three-dimensional miniature magnetic soft machines via multimaterial heterogeneous assembly. Science 6, 53 (2021). https://doi.org/10.1126/scirobotics.abful12

### Additional Disclosure—Variable Internal-Radius Components

Every year, infants are born with life-threatening congenital heart defects that need to be alleviated with corrective heart surgeries. In cases where blood flow through the main pulmonary artery is harmfully excessive, patients typically undergo palliative treatments such as pulmonary artery banding, which aims to reduce this blood flow to a healthier level. While traditional pulmonary artery banding has improved the survivability of infants with this affliction for decades, it often requires more than two risk-laden surgeries due to patient growth, loosening of the band, complications, and other issues. To address these shortcomings, we propose a novel, multistable pulmonary artery band inspired by origami. In addition to being cost effective and simple to deploy, this novel pulmonary artery band can be configured for magnetic control to reach its multiple stable states, potentially eliminating the need for more than one surgery for implanting the pulmonary artery band and one surgery to remove it.

### REBO Design Parameters

The fundamental design parameters of all REBO structures are α, a, b, n, and h. α is the angle of the diagonal fold-herein called the stability angle. a is the panel width, b is the width of panel overlap, n is the number of sides, and h is the panel height. It is important to note that all of the design parameters, besides n, can change between layers but should remain the same within a layer. If the parameters change between layers, it is good practice to use a layer index to each design parameter. For bistable REBO structures with uniform layers, the design parameters map to a set of geometric parameters which are described by the following equations:

$$θ = π - 2 α \qquad ( 2.1 )$$

$$ϕ = 2 π - n θ \qquad ( 2.2 )$$

$$β = arccos ( 1 - \frac{ϕ}{2 π} ) \qquad ( 2.3 )$$

$$z = h sin β \qquad ( 2.4 )$$

$$r = \frac{1}{2} ( a - b ) sec α cos β \qquad ( 2.5 )$$

θ is the angle that subtends a fold unit, ϕ is the overcurvature, and β is the elevation angle of a frustrum. The geometric parameters of chief interest in this thesis are z, the vertical height of each frustrum, and r, the inner radius of the REBO structure. An important characteristic of the REBO fold pattern is that, for a fixed a, uniformly scaling the parameters a, b, and h results in the r and z parameters being scaled by that same factor.

### State-Switch REBO Variant

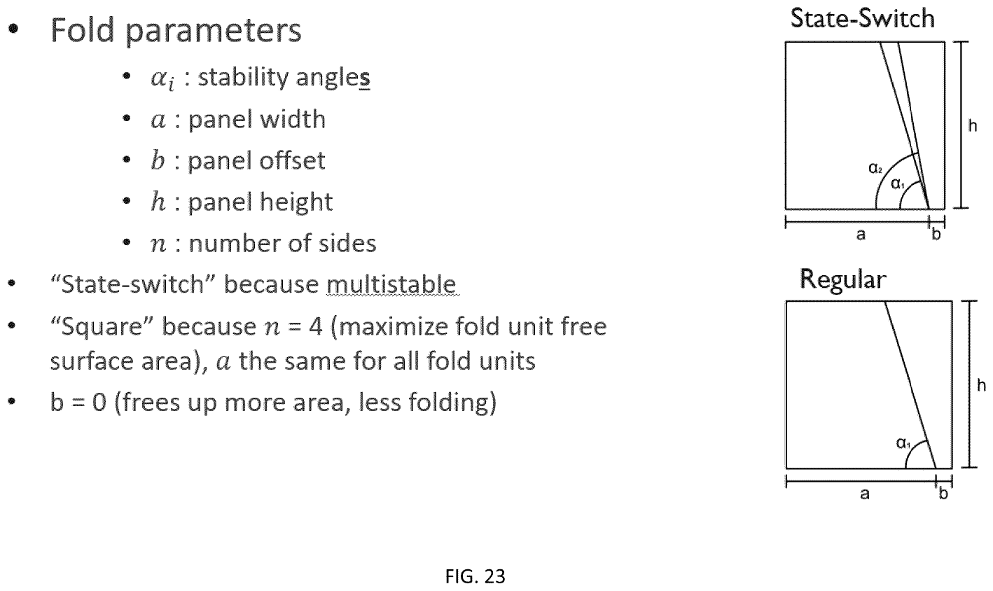

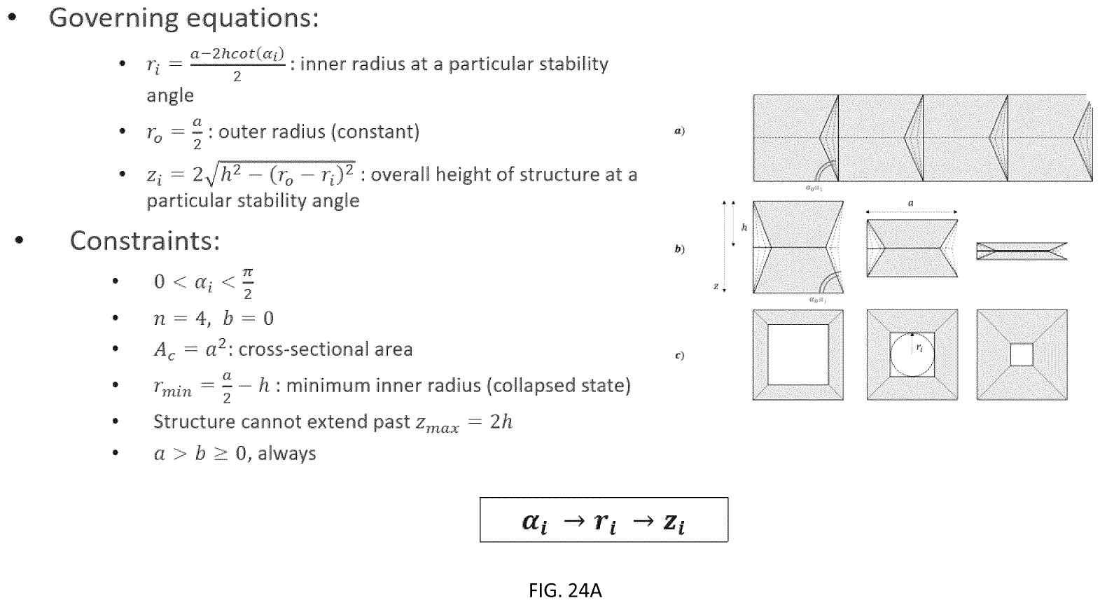

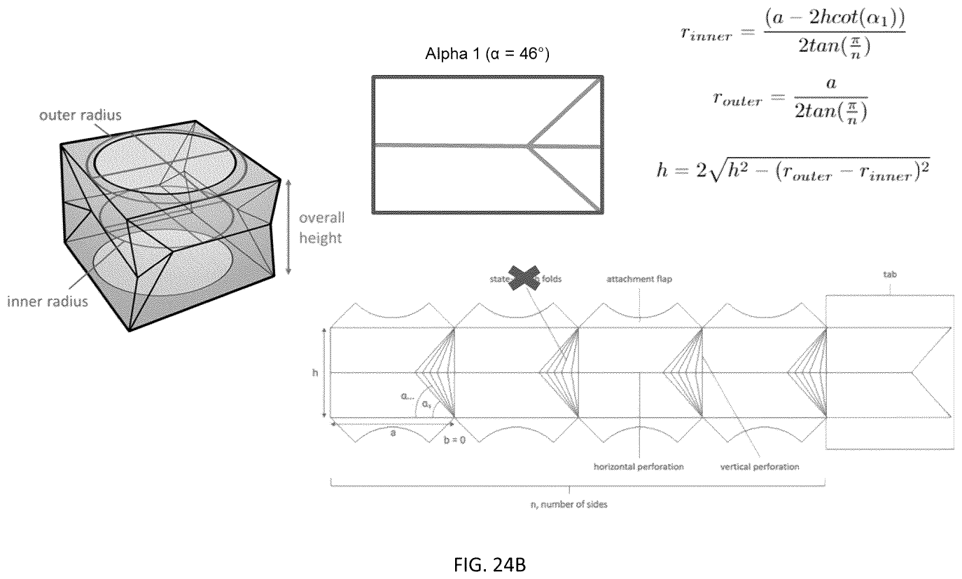

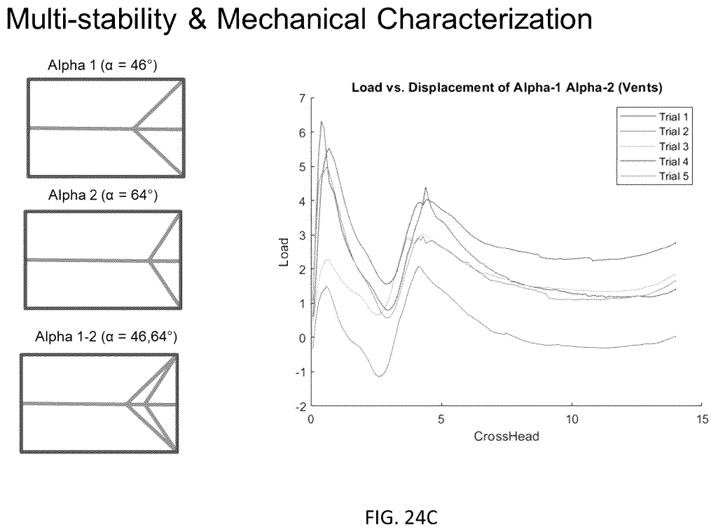

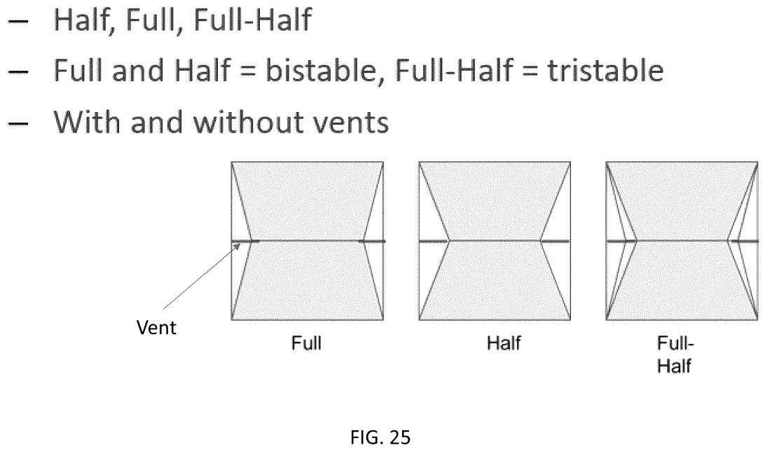

By adding more diagonal folds to the original REBO fold pattern, we can increase the number of stable states in the REBO structure (FIG. 23). Recall that the diagonal crease in the original REBO fold pattern has an angular offset from the horizontal fold axis equal to the chosen stability angle, α. In the REBO fold pattern, each diagonal crease represents a stable state in the resulting structure. This means that adding stability angles (diagonal creases) is tantamount to adding stable states. Because the REBO is bistable with only one stability angle, the number of stable states (ns) in a REBO structure is given by the expression:

$${n}_{s} = {n}_{α} + 1 \qquad ( 2.6 )$$

where n_{α} is the number of stability angles in the fold pattern. Introducing multiple stability angles, it becomes helpful to use index notation to distinguish between them. For example, one may use α₀ to refer to the stability angle corresponding to the first stable state and α₁ to refer to the second one. The indexed variable for stability angles would thus be αᵢ. This modified REBO pattern with multiple stability angle is referred to as a state-switch REBO pattern. Substituting Equations 2.1-2.3 into Equations 2.4 and 2.5, the geometric parameters z and r are redefined in a way that accounts for multiple stability angles:

$${z}_{i} = h sin ( arccos ( \begin{matrix}n ( π - 2 {α}_{i} ) \\ 2 π\end{matrix} ) ) \qquad ( 2.7 )$$

$${r}_{i} = \frac{1}{2} ( a - b ) sec ( {α}_{i} ) ( \frac{n ( π - 2 {α}_{i} )}{2 π} ) \qquad ( 2.8 )$$

zᵢ is the height of a frustrum and rᵢ is the inner radius of the REBO structure, both for a certain stability angle αᵢ.

### Untethered Control of Origami Structures

Untethered control can be defined as the manipulation of an object such that the power source and controller are physically separate from the actuator. In scenarios where direct mechanical input or control-by-wire is infeasible such as navigation of a robot within the human body, untethered control becomes a necessary. Examples of untethered control in biomedical applications include drug delivery, neurointerventional guidewire manipulation, wireless stimulation of an esophageal stent, and microsurgery assistance. There are many possible modalities of untethered control yet the effectiveness of these modalities depends on the problem at hand and it is worth doing a cost-benefit analysis among possible candidate methods.

Magnetic untethered control is a promising modality for origami structures due to its fast actuation speeds and its ability to work at different scales. In many studies on magneto-origami structures, researchers attach magnetic elastomers and other field responsive materials to the panels of an origami structure and demonstrated magnetic untethered control by altering the strength and direction of a uniform magnetic field. One simple and cost-effective way of generating a uniform magnetic field for testing is with a Helmholtz coil pair. With this device, the strength of the magnetic field can be adjusted by changing the amount of current sent through the coils and the orientation of the magnetic field can be adjusted by moving a field-responsive specimen or repositioning the coils. Magnetic untethered control in three dimensions can be accomplished by having three pairs of Helmholtz coils whose axes are perpendicular from each other.

### Pulmonary Artery Band

### Preliminary Design

We present the preliminary design of a novel origami-inspired PAB (OPAB). Its key features include having a scalable design, being easily fabricated with few constituent parts, being multistable, and being easily augmented for magnetic control. Here, we discuss the characteristics and fold parameters of the novel PAB's basal fold pattern, known as the Square State-Switch REBO (S-REBO) fold pattern. We then discuss how to choose a set of fold parameters that constitute a feasible design for the application of pulmonary artery banding and how to fabricate that design.

Like any single-layered state-switch REBO fold pattern, a S-REBO fold pattern typically has at least two stability angles (αᵢ), making it at least tristable. For the S-REBO, we made two design decisions that narrowed the range of fold parameters. The first decision was that there always four sides (n=4), giving it a distinctly square-shaped cross section. By having n=4, we preserve the characteristics of the REBO fold pattern and maximize the free space on each fold unit. The design decision was that there be no panel overlap (b=0). Similar to the n parameter design decision, the b parameter design decision maximizes free space on the structure and the availability of free space is necessary for eventually attaching magnetic material. From this point forward, the terms “OPAB” and “S-REBO” will be used interchangeably because both are fundamentally the same from a mechanics perspective.

### Square State-Switch REBO (S-REBO)

Like any single-layered state-switch REBO fold pattern, the S-REBO fold pattern typically has at least two stability angles (αᵢ), making it at least tristable. For the S-REBO, we made two design decisions that narrowed the range of fold parameters. The first decision was that there are four sides (n=4), giving it a distinctly square-shaped cross section. By having n=4, we preserve the characteristics of the REBO fold pattern and maximize the free space on each fold unit. The design decision was that there be no panel overlap (b=0). Similar to the n parameter design decision, the b parameter design decision maximizes free space on the structure and the availability of free space is necessary for eventually attaching magnetic material. From this point forward, the terms “OPAB” and “S-REBO” will be used interchangeably because both are fundamentally the same from a mechanics perspective.

### S-REBO Geometric Parameters

In pursuing an effective OPAB design, the geometric parameters must be tuned such that the inner diameter at each stable state sufficiently constrict the MPA while still minimizing the spatial volume of the structure. To this end, the geometric parameters of greatest interest are the inner radius and the overall height as these directly influence the cross-sectional area and the length of the OPAB, respectively.

Three general equations determine the inner radius and overall height of S-REBO structures². Inner radius is denoted by rᵢ, outer radius is denoted by rₒ. zᵢ is the overall height of the structure, from the broader base of one frustrum to the broader base of the other frustrum (also termed “frustum” in some instances). The outer radius (rₒ) is equal to half of the panel length (a) and is constant at all states.

$${r}_{i} = \frac{a}{2} - h cot ( {α}_{i} ) \qquad ( 3.1 )$$

$${r}_{o} = \frac{a}{2} \qquad ( 3.2 )$$

$${z}_{i} = 2 \sqrt{{h}^{2} - {( {r}_{o} - {r}_{i} )}^{2}} \qquad ( 3.3 )$$

Here, αᵢ denotes a finite set of stability angles that one would design into the fold pattern. However, these equations are valid for computing rᵢ and zᵢ of the S-REBO for any angle between the established maximum and minimum ones, inclusive.

### Relation Between Stability Angles, Radius, and Height

For all S-REBOs, the smallest stability angle corresponds to the minimum inner radius and the minimum height of the structure at a stable state. Conversely, the largest stability angle corresponds to the maximum inner radius and the maximum height of the structure at a stable state. Following this logic, the intermediate stable states-those with stability angles bounded between the minimum and maximum stability angles-will have a relative stable height that reflects the size ranking of their stability angles. For example, the second largest stability angle in a tristable S-REBO corresponds to the second largest stable height. In other words, a certain stability angle implies a certain inner radius which implies a certain overall height of the structure.

$${α}_{i} ⇒ {r}_{i} ⇒ {z}_{i} \qquad ( 3.4 )$$

### Geometric Boundaries

The maximum cross-sectional area of the frustra of a S-REBO structure, A_{c} does not change regardless of which stable state it is at. Because the S-REBO pattern is four-sided and has no panel overlap, A_{c} can be calculated with a simple equation:

$${A}_{c} = {( 2 {r}_{o} )}^{2} = {a}^{2} \qquad ( 3.5 )$$

In the fully-collapsed stable state, the height of the S-REBO structure is theoretically zero but this is not possible due to the folding sheet having a finite thickness. The actual height at full compression-however small-should be measured empirically. In contrast, the overall height of the structure at the fully-expanded stable state (zₘₐₓ) can be found by substituting the largest stability angle (αₘₐₓ) into Equation 3.1 and then substituting this result into Equation 3.3. Extruding the structure past this largest stable height, its overall height cannot exceed 2h.

To take full advantage of the S-REBO's multistability, one must select a set of fold parameters that results in a minimum inner radius that exists. The h and a parameters should therefore be chosen carefully because some combinations of these parameters could produce a structure where the side panels collide before a fully-collapsed stable state can be reached, eliminating one of the possible stable states. We estimate the minimum inner radius with Equation 3.1, and set

$$α = \frac{π}{n}$$

radians, where n=4 for the S-REBO. The fully-collapsed stable state exists so long as rₘᵢₙ is greater than zero:

$${r}_{min} = \frac{a}{2} - h , {r}_{min} > 0 \qquad ( 3.6 )$$

As a final note, all REBO fold patterns can have a panel length and panel overlap that satisfy this compound inequality:

$$a > b \geq 0 \qquad ( 3.7 )$$

### Prototyping Feasibility Tool

To help in translating the dimensional constraints and S-REBO fold parameters into a viable OPAB prototype, we developed a visual tool for determining the feasibility of a S-REBO prototype for a given set of fold parameters. The constraints listed in Table 3.1 ensure that the OPAB occupies minimal volume and does not intrude on surrounding tissue when collared around the SVD neonate's MPA. Interpreting these constraints through the lens of S-REBO fold parameters, we set Equation 3.2 less than or equal to the maximum inner diameter constraint in Table 3.1 and intuit from Section 3.2.3 that h must be less than or equal to 5 mm to satisfy the end-to-end constraint in Table 3.1. We thus arrive at the following maximum parametric constraints:

$$a \leq 10 \qquad ( 3.8 )$$

$$h \leq 5 \qquad ( 3.9 )$$

The Prototyping Feasibility Tool provides a two-dimensional plot of the inner radius and the overall height of an S-REBO structure for a given a, b, and h. The vertical axis is in length units and horizontal axis is in units of radians. To use the script, the user inputs the S-REBO fold parameters (a, a, b, h, and n) and a set of desired stability angles and the corresponding desired inner radii (Ides) and desired heights (z_{des}) are automatically calculated based on the fold parameters. Once the script is run, five distinct lines are plotted:

Solid red line The inner radius (rᵢ).
Solid blue line The overall height (zᵢ).
Black dashed lines The selected stability angles (αᵢ).
Red dash-dotted lines The desired inner radii at a stable state (r_{des}).
Blue dash-dotted lines The stable heights resulting form the desired inner radii (z_{des}).
Solid magnenta line The inner radius at the collapsed stable state (rₘᵢₙ). For a prototype to be feasible, it must appear on the plot.

In an example feasibility map (FIG. 34), the intersection of any αᵢ with rᵢ and r_{des} left of

$$\frac{π}{2}$$

radians is interpreted as proof of a viable stable state. The smallest stability angle is the furthest left of the dashed black lines. For the smallest angle, the corresponding smallest stable height is the lowest of the blue dash-dotted lines and the smallest inner radius at a stable state is the lowest of the res dash-dotted lines. The input parameters and desired outputs used to generate the feasibility map are tabulated in Table 3.2. this tool helps one get a sense of how the inner radii and overall heights of the S-REBO change for different choices of the input parameters and is thus useful in selecting these parameters.

### MTS Testing

Because 1×-scale OPAB prototypes are difficult to fabricate en masse, we instead fabricated up-scaled prototypes ranging from 2×-scale to 7×-scale. The goal was to use these upscaled prototypes to generate a series of force-displacement curves that would assist us in predicting the force-displacement curve for the 1×-scale OPAB. In particular, we were interested in tracking the peak force of each curve and noting how it trends across scales. These tests were performed using an MTS Criterion Series 40 Load Frame with a 50 kN load cell (herein MTS machine). S-REBO prototypes at each scale were axially compressed tests to generate force versus displacement curves. For each test, OPAB prototypes were constrained within the MTS machine's testbed with custom-printed attachment made from PLA.

### DISCLOSURE

The significant physical changes that pediatric patients undergo make effective implant development an ongoing clinical challenge. Most commercially available implants fail to accommodate growth, leading to reduced efficacy and potential complications. This inadequacy results in frequent reoperations, imposing substantial physical and financial burdens, especially for high-risk conditions like congenital heart diseases. For modulating blood flow in such cases, a remotely reconfigurable implant with a variable diameter within a constrained volume would be advantageous, and given the slow progression of growth and solely periodic adjustments, it would be energetically advantageous to utilize a non-powered structure. Multistable structures, which maintain configurations passively and require power only for transitions, are ideal. However, the actuation force needed to change between positions must be carefully tuned to enable selective actuation.

We explore the novel application of a multistable origami structure in pediatric flow-modulating implants. The State-Switching Reconfigurable Expanding Bistable Origami (SREBO) pattern, an origami bellows pattern with multiple stable states, is a promising candidate. To fulfill the need for remote reconfiguration, we control the SREBO using magnetic panels for actuation, an approach that has been used successfully on other patterns. The addition of folds and stable states in the SREBO pattern can affect the force needed to change between positions. To guide implant design, we examine the force response of vertical compression of the SREBO after varying geometric, material, and scale parameters. From this, we find consistently increasing forces in thickness and size scaling, but variable forces as we change stable state geometries.

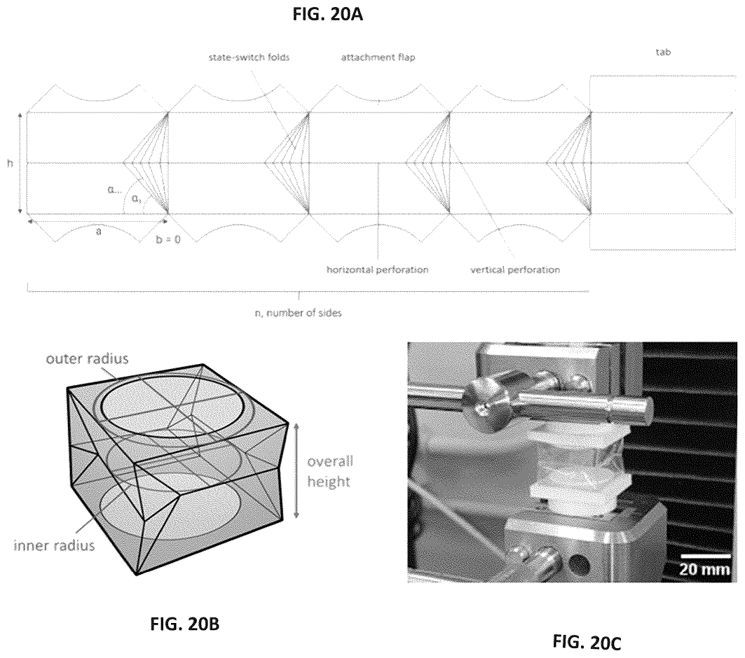

A geometric analysis of a compressed SREBO can identify the relationships between the stable states, associated heights, and inner diameters. This model relates the inner and outer radius based on pattern parameters: side length a, panel height h, state-switch fold angle α, and the number of sides n (FIG. 20A). Additionally, it derives the relationship between the inner radius, outer radius, and the overall height of the structure (FIG. 20B). These equations were used to tune parameters for target stable heights and diameters. The patterns were fabricated from PET sheets cut and perforated on a laser cutter, then manually folded. The SREBOs were finalized by joining an overlapping tab, and then adhering top and bottom reinforcing panels.

Average force peaks of either single- or multi-state SREBOs (a=8.17 mm, h=5.4, alpha=48.55°, n=4) were measured while varying several factors: PET thickness (0.001″, 0.002″, 0.003″), size scale (2×, 2.5×, 3×, 4×, 5×, 6×), and the a angles of the state-switch fold (30°, 40°, 45°, 55°, 60°, 65°). For each trial, the model was secured to a 3D-printed test holder and then mounted to an MTS Electromechanical Test Machine (FIG. 20C). During each trial, models were compressed to the theoretical maximum switch-state compression. Maximum peak force and cross-head location were recorded, demonstrating the force needed to switch states. The data was processed to find the average peak force and standard deviation.

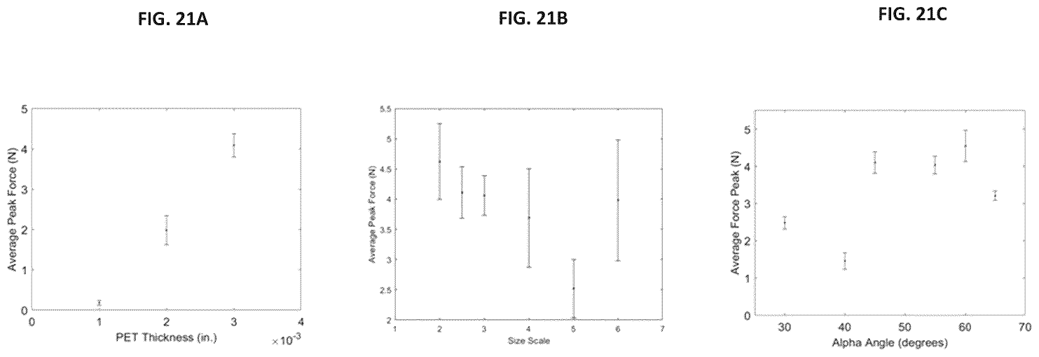

For single-state SREBOs, we observed that thickness and size scaling presented relatively consistent force patterns, while geometric manipulations yielded variable changes. Increasing thickness led to continually rising average force peaks (FIG. 21A). Varying size scales from 2× to 5× showed a downward trend in average force peaks (FIG. 21B). The 6× scale deviates from the pattern of decreasing force peaks, but this may be attributed to an outlier peak of 6.01N during the first trial. Varying alpha angles yielded the highest forces between 45 and 60 degrees, declining at higher and lower angles (FIG. 21C). No peaks were observed at 30 degrees, which suggests force-loading being distributed at low angles and a switch-point of multistability based on manufacturing methods and geometries.

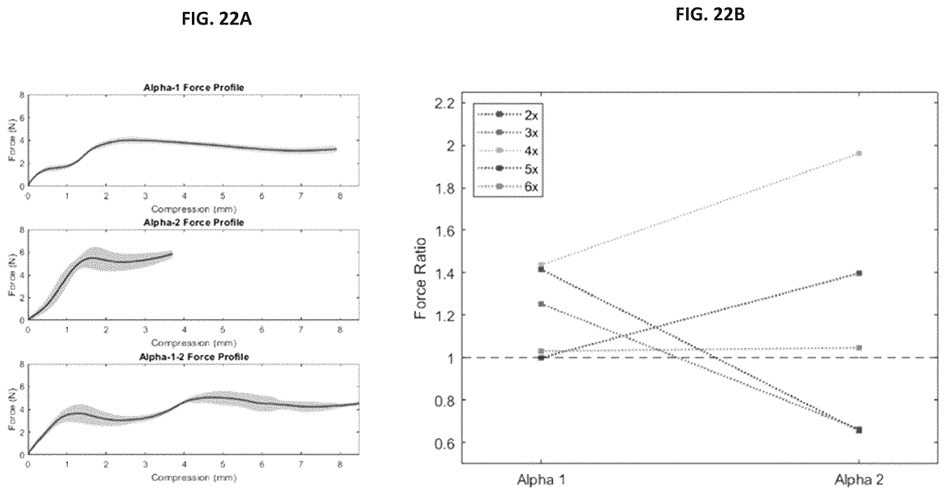

To characterize the impact of overlaid folds, pattern variations with a 46° state-switch fold (“Alpha-1”), a 64° state-switch fold (“Alpha-2”), and the overlaid combination of both folds (“Alpha-1-2”) were tested (FIG. 22A). Paired force peaks and force dips are present in Alpha-1-2 data, corresponding with actuation forces and stable states, respectively. Normalized force ratios are the peak force of an Alpha-1-2 model (averaged across all trials) divided by its single-fold counterparts. Alpha-1 normalized force ratios are consistently greater than 1, indicating that multi-fold models increased the average force peak value of the Alpha-1 fold (FIG. 22B). However, there Alpha-2 normalized force ratios varied. This suggests that adding new stable states increases the force required to switch stable states, dependent on the angle of the state-switch fold.

This study demonstrates the design and construction of a multistable implant candidate and the impact of SREBO pattern manipulations on actuation force. Consistency in thickness or size scale changes are encouraging indicators that multistability can be reliably predicted when adjusted for different implant applications. These force trends suggest that actuation force can be adjusted to ensure selective actuation. The variable behaviors with different fold angles or overlaying folds indicate a need for further investigation into the interplay between stable state actuation forces and pattern geometry. Pursuing a comprehensive model will enable more accurate control of multistable SREBO structures for reconfigurable implant applications.

### REFERENCES

[1] Crago, M., Winlaw, D. S., Farajikhah, S., Dehghani, F., & Naficy, S. (2023). Pediatric pulmonary valve replacements: Clinical challenges and emerging technologies. Bioengineering & Translational Medicine, 8 (4), e10501. https://doi.org/10.1002/btm2.10501
[2] Scafa Udrişte A, Niculescu A G, Grumezescu A M, Bădilă E. Cardiovascular Stents: A Review of Past, Current, and Emerging Devices. Materials (Basel). 2021 May 12; 14 (10): 2498. doi: 10.3390/mal4102498. PMID: 34065986; PMCID: PMC8151529.
[3] Macki, Mohamed M D, MPH: Hamilton, Travis M D: Haddad, Yazeed W B S: Chang, Victor M D. Expandable Cage Technology-Transforaminal, Anterior, and Lateral Lumbar Interbody Fusion. Operative Neurosurgery 21 (Supplement_1): p S69-S80, July 2021. | DOI: 10.1093/ons/opaa342
[4] J. Carlson, J. Friedman, C. Kim and C. Sung, “REBOund: Untethered Origami Jumping Robot with Controllable Jump Height,” 2020 IEEE International Conference on Robotics and Automation (ICRA), Paris, France, 2020, pp. 10089-10095, doi: 10.1109/ICRA40945.2020.9196534.
[5] Novelino, L. S., Ze, Q., Wu, S., Paulino, G. H., & Zhao, R. (2020). Untethered control of functional origami microrobots with distributed actuation. Proceedings of the National Academy of Sciences, 117 (39), 24096-24101. https://doi.org/10.1073/pnas.2013292117
[6] Hongbin Fang et al (2020). Magneto-origami structures: engineering multi-stability and dynamics via magnetic-elastic coupling. Smart Mater. Struct. 29 015026. doi: 10.1088/1361-665X/ab524e
[7] Li, Yi & Avis, Samuel & Kusumaatmaja, Halim & Zhang, Teng & Wang, Xueju. (2021). Tailoring the Multistability of Origami-Inspired, Buckled Magnetic Structures via Compression and Creasing. Materials Horizons. 8. 10.1039/DIMH01152A.

### Adding Vents

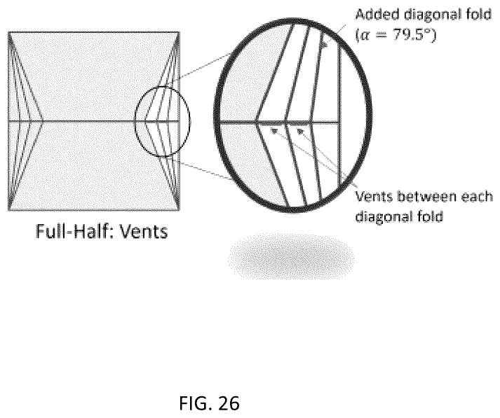

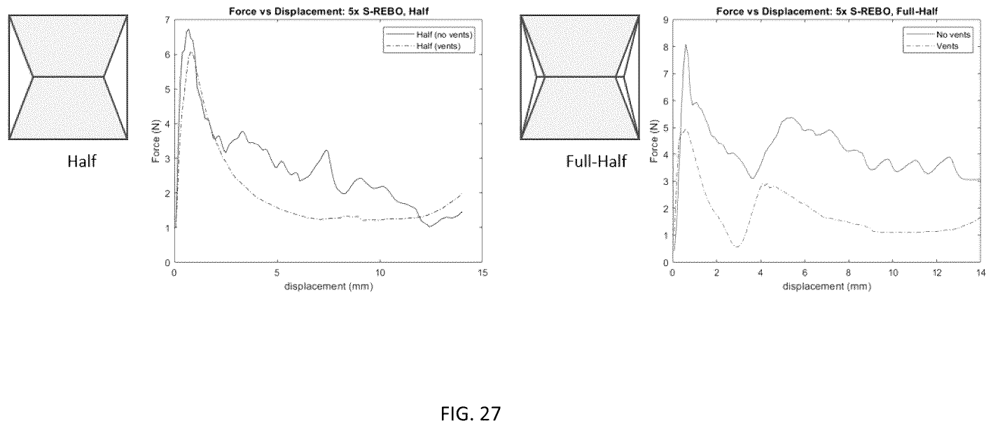

For some specimens such as “half 5×-scale,” the 3PAB results had small oscillations which gave them an “un-smooth” appearance. Moreover, in some cases, the curves would not exhibit the behavior we expected such as falling to zero after the first force peak (see Appendix E). This could be explained by the crude fabrication procedure, mainly in terms of how each prototype was lasercut, folded, and taped. Minute differences in the execution of each of these steps may have led to different levels of damage or deformation for prototypes during the MTS testing of the 3PAB experiment, skewing the mechanical characterization data. To address this, we made another batch of specimens in which we added a large stability angle (α=79.5°) and used the lasercutter to make small incisions called vents between all of the diagonal creases at each corner of the structure (FIG. 26). Adding vents usually produced smoother force curves with behavior that more closely aligned with our expectations. Vented specimens also appeared to be less stiff with their peak forces being usually lower than their counterparts without vents. To produce the vented specimens for comparison, the DXF file of a normal S-REBO pattern was modified by adding a vector cut between each diagonal crease.

The general differences between the force-displacement curves of the vented specimens and the non-vented specimens may be owed to the de-stiffening effect of the vents. Because all specimens are fabricated by wrapping the extra fold unit around the first fold unit, one of the four sides of the structure will be stiffer than the other three. Therefore, the in-plane and out-of-plane bending experienced by this stiffer side may not be the same as for the other three sides under axial compression, leading to less uniform deformation of the structure on each side. If this was the issue, vents appeared to somewhat nullify the skewing of results due to non-uniform side stiffness.

### OPAB Test Prototype

A 2×-scale OPAB test prototype was used for simulated in-vivo testing in the mock circulation loop. The choice of scale is due to most of the structural tubing of the MCL having an outer diameter that is about 2.116× the size of a neonatal MPA. The fold parameters of the test prototype were adjusted for the structure to have a minimum inner radius of 4 mm to more drastically reduce the flowrate of fluid through the MMPA at the fully-collapsed stable state. The body of the test prototype, consisting of the five fold units, was made from 0.003″ (0.0762 mm) PET. The reinforcement panels were made from 0.005″ (0.127 mm) PET.

### Magnetic Designs

### Magnetic Panels

To accomplish magnetic untethered control of the OPAB, one can attach field responsive materials to the free space of its fold panels so that it can switch between stable states under the influence of a magnetic field. These magnetic panels have seen use in the untethered control of magneto-origami structures and often take the form of magnetic elastomers and permanent magnets. Whichever form they take, magnetic panels can be polarized in the desired direction with a strong electromagnet to prime them for the desired folding behavior.

The optimal placement of magnetic panels on an origami structure is a function of the fold pattern's properties, the properties of the magnetic panels, and the desired folding behavior. Generally, it is desirable for the magnetic panels to be thin and low-weight to maintain the manifold advantages of an origami structure. For preliminary magnetic testing, we fabricated a 3×-scale cornerless magnetic S-REBO or CMS-REBO out of PET and 0.6 mm-thick refrigerator magnets (X-bet MAGNET). Unlike regular S-REBO prototypes, this version did not have any material to the right of its singular stability angle creases thereby making it far less stiff than a regular S-REBO.

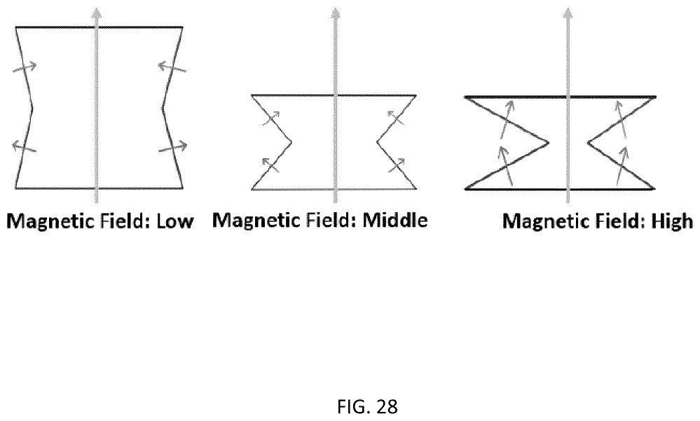

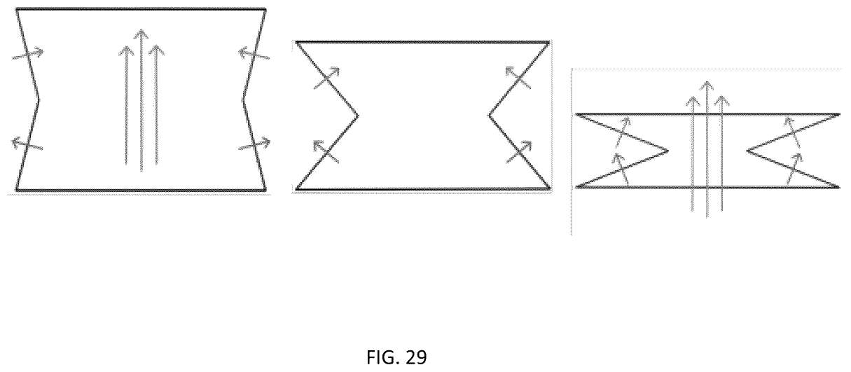

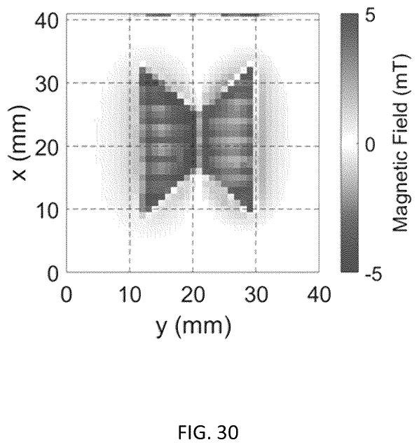

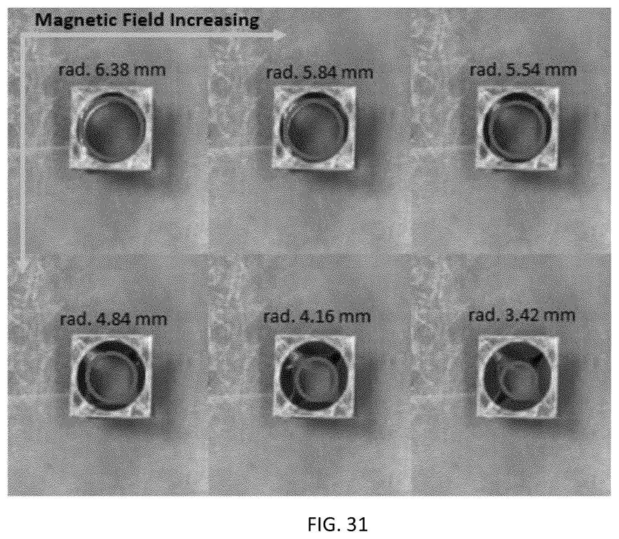

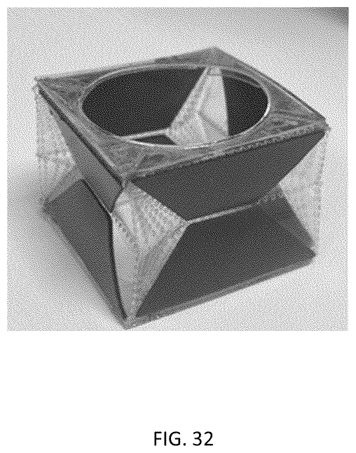

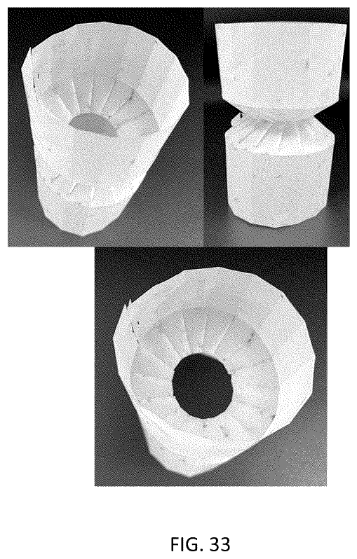

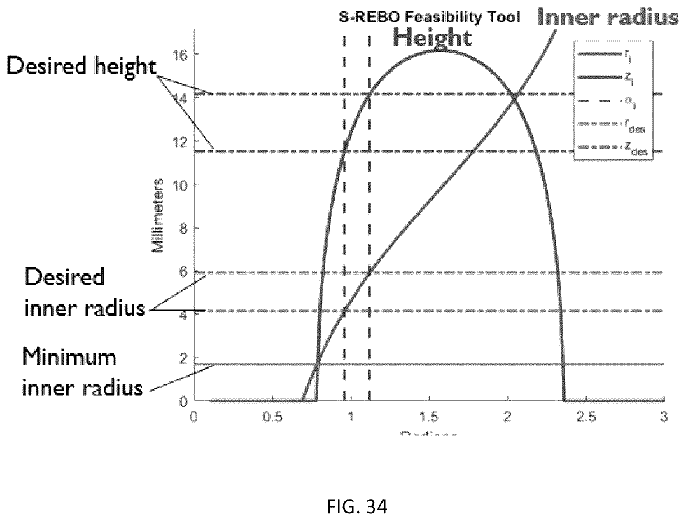

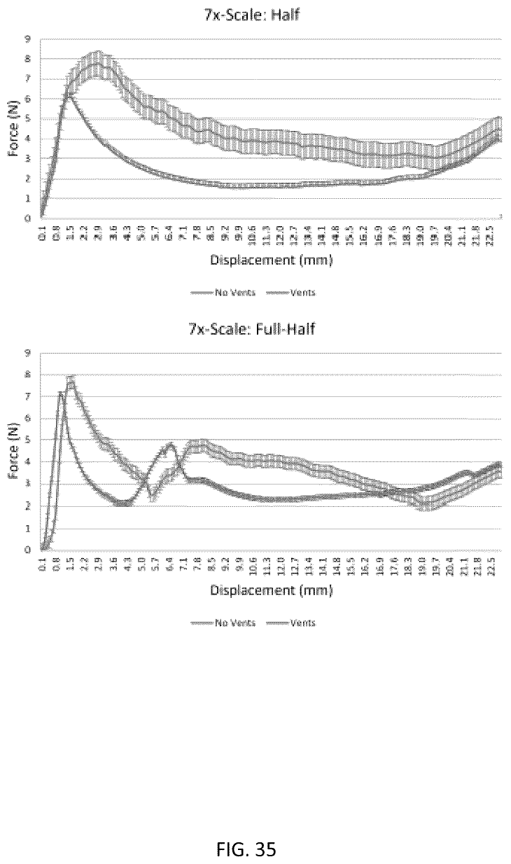

For the S-REBO in particular, we magnetized the top panels in the opposite direction of the bottom panels such that, when a magnetic field passes through the structure in the axial direction, the structure will either collapse or expand (FIG. 28). We term this folding behavior a book fold due to the ensuing change in the structure resembling the opening or closing of a book, depending on the direction of the magnetic field. To execute a book fold, we use a magnetic write head which functions similarly to a hard-drive disk reader in computers to align the magnetic particles in either the north the south directions. Pixel by pixel, the upper frustra magnetic panels were programmed in the northern direction and the lower frustra magnetic panels were programmed in the southern direction.

### Magnetic Actuation

### Helmholtz Coils

For a simple and cost-effective demonstration of magnetic untethered control on a magnetic S-REBO, one can use Helmholtz coils. A Helmholtz coil is a hollow cylinder wrapped in wire that generates a uniform magnetic field through its middle when current is run through the wires. Two Helmholtz coils can be positioned co-axially to generate a nearly uniform magnetic field between them provided that both are the same size and the space between them is equal to the radius of one of the coils. The input current through the coils (I) and the output magnetic field strength (B) are related by the equation:

$$B = {( \frac{4}{5} )}^{\frac{3}{2}} \frac{{μ}_{0} NI}{R} \qquad ( 7.1 )$$

where μ₀ is the permeability of free space, N is the number of turns of wire around each coil, and R is the inner radius of the coil. As seen in Equation 7.1, if the desired magnetic field strength is known, then one may select arbitrary values of the parameters N, I, and R to balance the equation and arrive at a Helmholtz coil design.

After it was programmed and assembled, the CMS-REBO was tested with a single Helmholtz coil, and it was found that applying a field of 45 mT resulted in the complete collapse of the structure. We then ran a force-displacement test with the MTS machine and found that the CMS-REBO experiences a peak force of about 0.9 N.

### Torque-Based Estimation

Force-displacement data was used to estimate the torque on a S-REBO at each displacement step. The model is based on a cutaway view of the S-REBO which consists of rigid linkages with the bottom right point assumed to be constrained to the ground. The force from the MTS machine is assumed to be applied at the top right corner by the loading frame. A force of similar magnitude is assumed to be applied at the bottom right corner in reaction to the upper force. To calculate torque, we calculate the instantaneous moment arm, which is the perpendicular distance between the upper applied force and an inner radius point at a specific displacement step. The instantaneous moment arm is then multiplied by the corresponding force at that displacement step to get instantaneous torque. Upon plotting a torque versus displacement curve, the peak torque is extracted and substituted into the equation:

$$τ = m \times B = mB sin θ \qquad ( 7.2 )$$

where m is the magnetic pole strength of the magnetic panel, B is the external magnetic field in which the magnetic panel is situated, t is the peak torque on the magnetic panels, and θ is the angular displacement between the direction of the magnetic field of the magnetic panels and the external magnetic field lines. Magnetic pole strength is itself given by:

$$m = \frac{{B}_{r} V}{{μ}_{0}} \qquad ( 7.3 )$$

where Bᵣ is the remnant magnetic field of the panel, V is the volume of the magnetic panel, and μ₀ is the permeability of free space. In this model, the V term is computed as the volume of all magnetic panels on both the upper and lower frustra of the CMSREBO, of which there are eight. Assuming that the magnetic panels are perfectly trapezoidal and use up all of the free space on each fold unit, V (in m³) is:

$$V = 8 {t}_{mag} ( ah - {h}^{2} cot ( {α}_{0} ) ) \qquad ( 7.4 )$$

### Aspects

The following Aspects are illustrative only and do not limit the scope of the present disclosure or the appended claims. It should be understood that any part or parts of any Aspect can be combined with any part or parts of any other Aspect.
Aspect 1. A method, comprising: applying a magnetic field from a magnetic field source to a magnetizable substrate sheet that is in a first configuration, the magnetizable substrate sheet comprising a first rotatable element that (i) comprises a first magnetic pattern and (ii) is configured to rotate about an axis extending in a first direction, the first magnetic pattern comprising a region of a first magnetic polarity, the magnetic field rotating the first rotatable element as to convert the magnetizable substate sheet to a second configuration in which second configuration the first rotatable element magnetically affixes to a second element of the magnetizable substrate sheet, the second element having a second magnetic pattern thereon, the second magnetic pattern comprising a second magnetic polarity, and the second element optionally being rotatable.
Aspect 2. The method of Aspect 1, wherein the first magnetic pattern is characterized as pixelated.
Aspect 3. The method of any one of Aspects 1-2, wherein the first rotatable element is rotatable about an axis extending in a second direction that is offset from the first direction.
Aspect 4. The method of any one of Aspects 1-3, further comprising effecting relative motion between the magnetic field source and the magnetizable substrate sheet.
Aspect 5. The method of any one of Aspects 1-4, wherein the first configuration of the magnetizable substrate sheet is substantially planar.
Aspect 6. The method of any one of Aspects 1-5, wherein the second configuration of the magnetizable substrate sheet is a folded configuration that corresponds to a step of a folding sequence that converts the magnetizable substrate sheet from the first configuration to a final configuration.
Aspect 7. The method of Aspect 6, wherein the final configuration is two-dimensional.
Aspect 8. The method of Aspect 6, wherein the final configuration is three-dimensional.
Aspect 9. The method of any one of Aspects 6-8, wherein the final configuration is any one or more of a cylindrical grasper, a spherical grasper, a hook grasper, a pinch grasper, a tripod grasper, or a lumbrical grasper.
Aspect 10. The method of any one of Aspects 1-9, further comprising defining the first magnetic pattern on the first rotatable element.
Aspect 11. The method of any one of Aspects 1-10, wherein the magnetic field is applied according to a predetermined schedule.

As shown in the appended figures, one can include in a magnetizable substrate sheet a thermosensitive material (e.g., a thermoplastic, such as PLA) to add stiffness into the structure. Such configurations are incapable of folding with the external magnetic field alone and require heat to soften the thermosensitive material until the point it can fold, but not break/deteriorate. Once cooled down, the sample attains (or re-attains) a rigidity. It should be understood that a given substrate sheet can include regions or patches of thermoplastic and also regions of non-thermoplastic. In this way, a given sheet can have regions that can actuated by application of a magnetic field without the further application of heat to soften a thermoplastic as well as regions that require application of heat to soften a thermoplastic before application of a magnetic field will effect motion of the region.

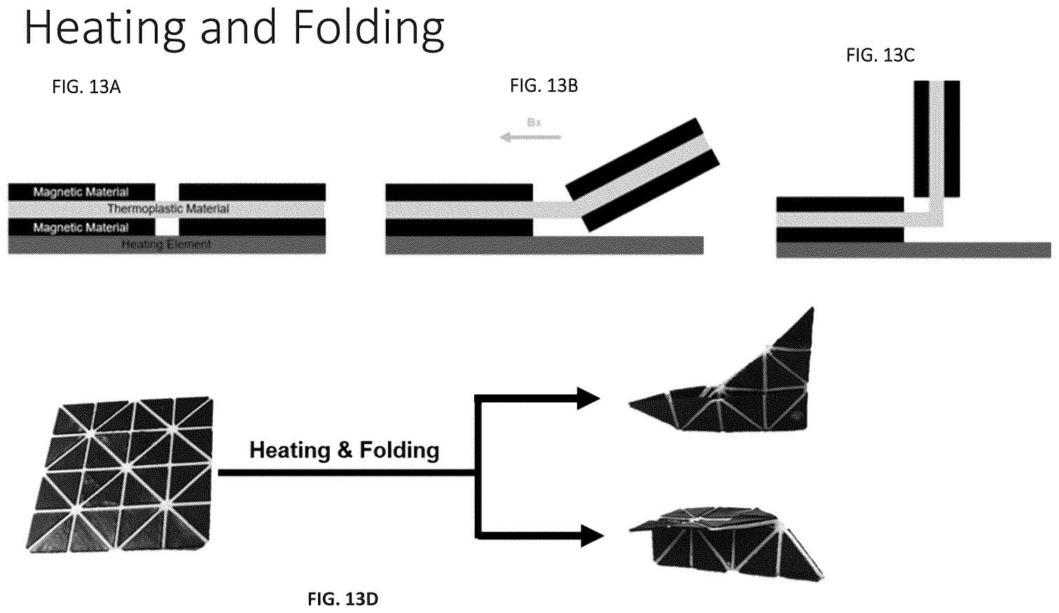

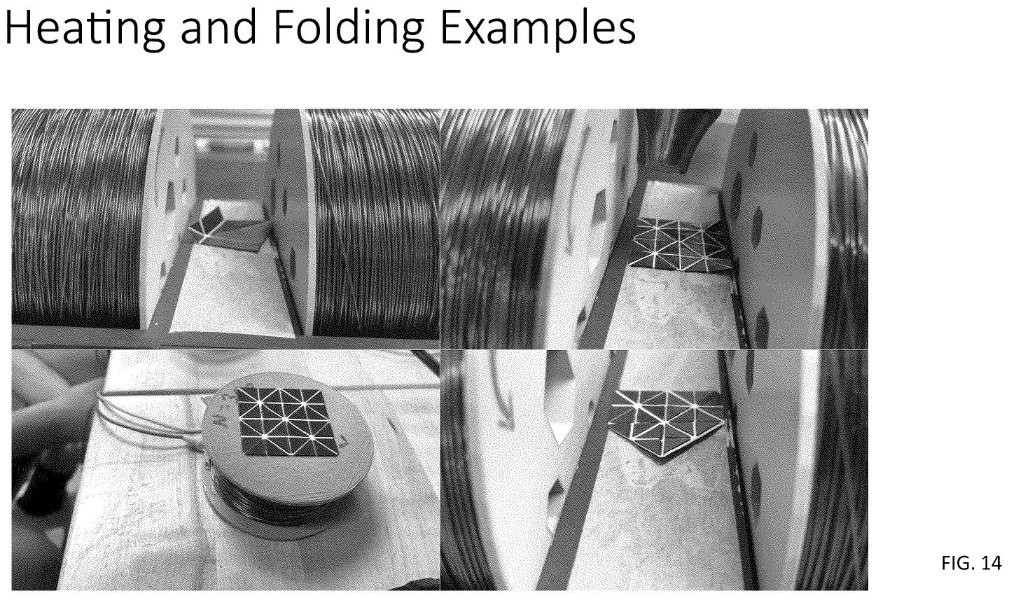

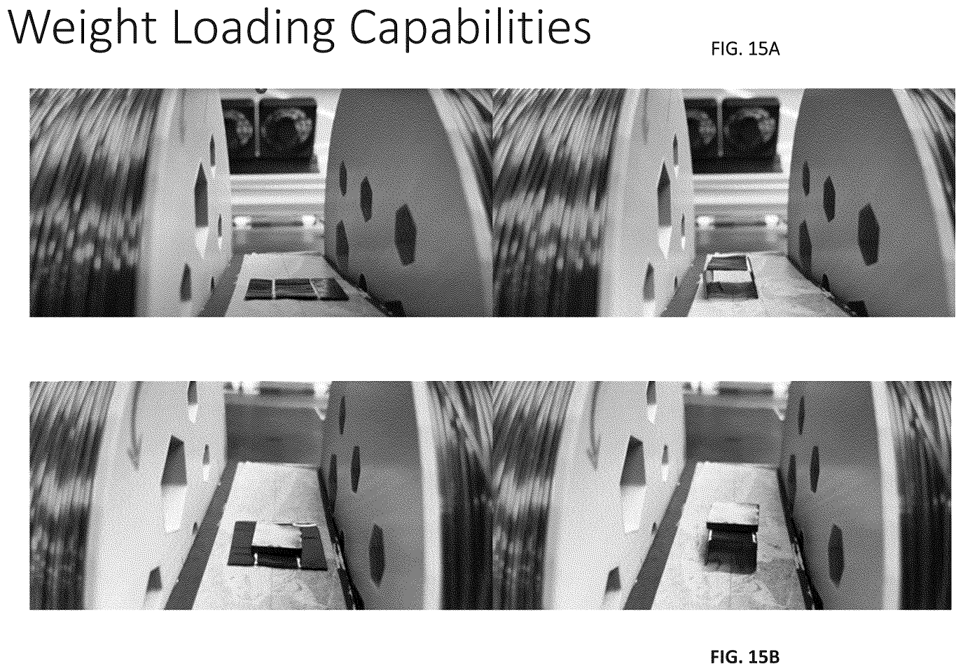

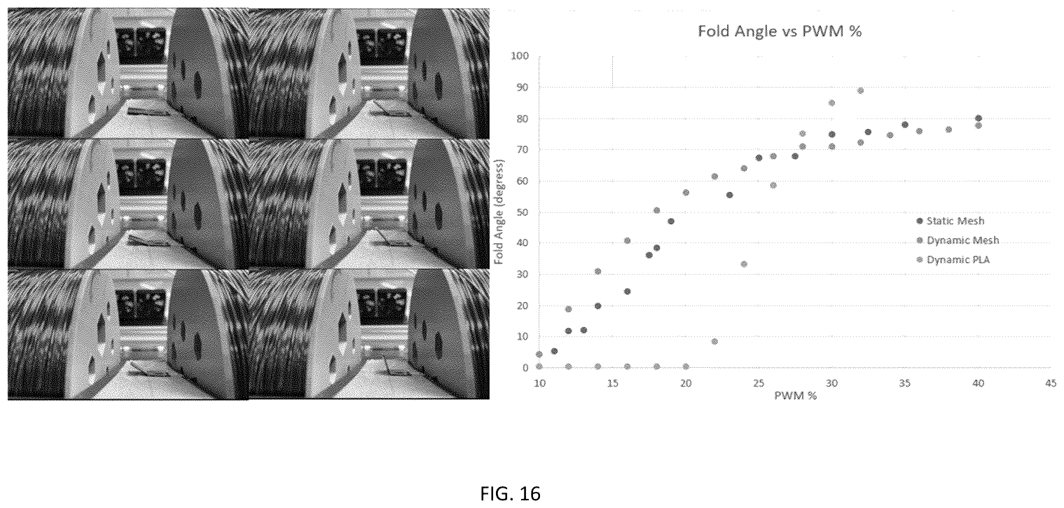

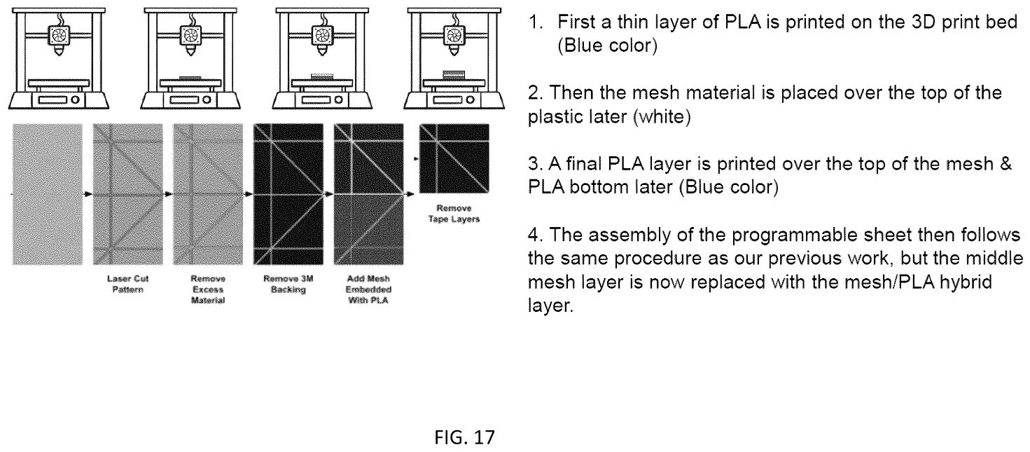

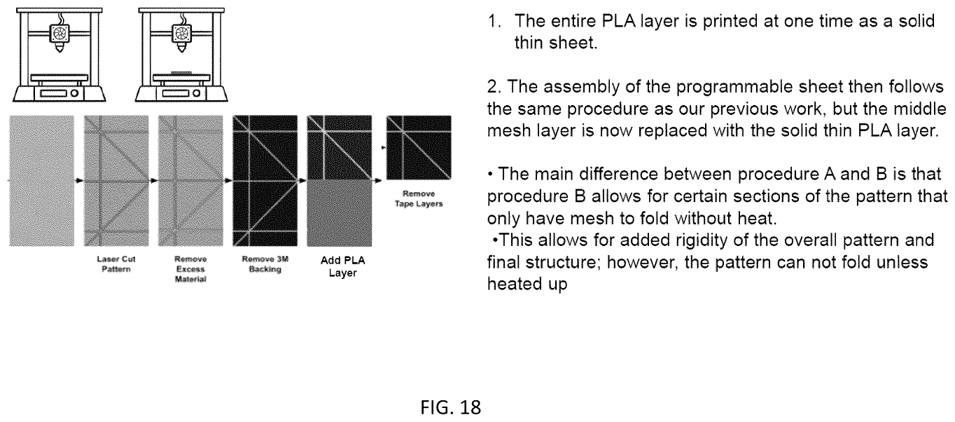

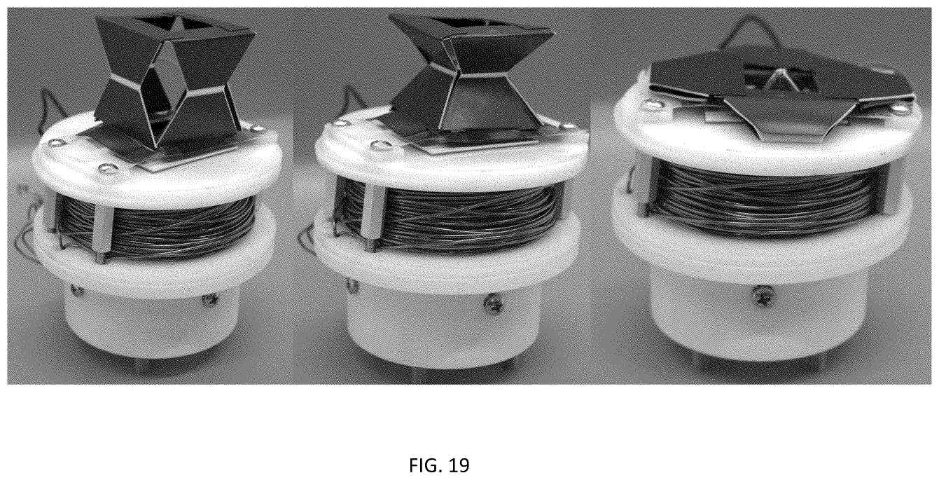

FIG. 13 provides example heating and folding steps, showing the use of a thermoplastic material: as shown, a sheet can be moved between a first rigid state and a second rigid state. (A) cross section view of a sheet. (B) The sample is first heated up to the glass transition temperature, and then the external magnetic field is turned on. (C) The heating element is turned off, and the magnetic field is left one while the sample cools down and solidifies. (D) Example patterns of how the heating and folding can be used in conjunction with a universal pattern to be folded, and solidified into different final structures. It should be understood, however, that a given sheet need not include thermoplastic throughout, as the sheet can include regions of thermoplastic between magnetic material as well as regions of non-thermoplastic (such as a mesh) between magnetic material.

It should also be understood that a sheet can include a flexible printed circuit board between two magnetic sheets. In this way, a computing device or other electronic device can be comprised in a component according to the present disclosure. Such a device can be, for example, a sensor, a controller, or other such device.
Aspect 12. The method of any one of Aspects 1-11, wherein the magnetizable substrate sheet comprises a thermosensitive material.
Aspect 13. The method of Aspect 12, wherein the thermosensitive material is a thermoplastic.
Aspect 14. The method of Aspect 13, wherein the thermoplastic comprises polylactic acid (PLA). The thermoplastic need not be PLA, however, the thermoplastic can comprise any one or more of polyethylene (PE), polypropylene (PP), polytetrafluoroethylene (PTFE), polymethylmethacry late (PMMA), polyamide (nylon), and polyethylenterephthalate (PET). The thermosensitive material can also comprise, for example, stainless steel.
Aspect 15. The method of any one of Aspects 12-14, further comprising application of sufficient heat to soften the thermosensitive material.
Aspect 16. The method of Aspect 15, wherein the application of sufficient heat places the first rotatable element into a rotatable state.
Aspect 17. The method of Aspect 15, wherein the rotatable is not in a rotatable state absent application of sufficient heat.
Aspect 18. A system, the system comprising: a magnetic write head, the magnetic write head being configured to define a magnetic pattern on a magnetizable substrate sheet; and a magnetic coil, the magnetic coil being configured to apply a magnetic field to a magnetizable substrate sheet so as to effect folding of the magnetizable substrate sheet.
Aspect 19. The system of Aspect 18, further comprising an actuator configured to effect relative motion between the magnetizable substrate sheet and the magnetic write head.
Aspect 20. The system of any one of Aspects 18-19, further comprising a heat source.
Aspect 21. The system of any one of Aspects 18-20, wherein the magnetic write head defines a first pole and a second pole, the magnetic write head being arranged such that a magnetic flux is communicated between the first pole and the second pole, and optionally wherein the magnetic flux is denser at one of the first pole and the second pole than at the other of the first pole and the second pole.
Aspect 22. The system of any one of Aspects 18-21, wherein the magnetizable substrate sheet comprises a plurality of elements, each of the elements being rotatable about at least one axis.
Aspect 23. The system of Aspect 22, wherein the magnetizable substrate sheet comprises a thermosensitive material arranged so as oppose rotation by an element when the thermosensitive material is in a comparatively cool state and permit rotation by the element when the thermosensitive material is in a comparatively warmed state. The thermosensitive material can be a material that is rigid at room temperature and softens at elevated temperatures, for example at temperatures above room temperature.
Aspect 24. The system of Aspect 23, wherein the thermosensitive material is a thermoplastic. A thermoplastic can be, for example, PLA.
Aspect 25. The system of any one of Aspects 18-24, further comprising a memory configured to store instructions for operating any one or more of the write head, the magnetic coil, and the heat source so as to convert the magnetizable substrate sheet from a first folding state to a second folding state.
Aspect 26. The system of Aspect 25, wherein the instructions comprise at least one pixelated magnetic image corresponding to (i) the second state of the magnetizable substrate sheet and/or (ii) an intermediate folding state of the magnetizable substrate sheet between the first folding state and the second folding state.
Aspect 27. A method, comprising: determining a folding pattern and a folding sequence for converting a magnetizable substrate sheet from an initial folding state to a final folding state, the magnetizable substrate sheet comprising a first rotatable element that (i) comprises a first magnetic pattern and (ii) is configured to rotate about an axis extending in a first direction; and defining on the magnetizable substrate sheet a pixelated magnetic pattern that corresponds to a folding pattern and a folding sequence for converting of the magnetizable substrate sheet from the initial folding state to the final folding state.
Aspect 28. The method of Aspect 27, further comprising converting the folding pattern and the folding sequence to at least one pixelated magnetic image representative of a sequence of one or more configurations of the magnetizable substrate sheet between the initial folding state and the final folding state.
Aspect 29. The method of Aspect 28, wherein the pixelated magnetic pattern defined on the magnetizable substrate sheet is derived from the at least one pixelated magnetic image representative of one or more configurations of the magnetizable substrate sheet between the initial folding state and the final folding state.
Aspect 30. The method of any one of Aspects 27-29, wherein the defining is effected by relative motion between a magnetic coil and the magnetizable substrate sheet.
Aspect 31. The method of any one of Aspects 27-30, wherein the magnetizable substrate sheet further comprises a thermosensitive material, the thermosensitive material being arranged so as oppose rotation by an element when the thermosensitive material is in a cool state and permit rotation by the element when the thermosensitive material is in a warmed state, the thermosensitive material optionally being a thermoplastic.
Aspect 32. A method, comprising: with a magnetizable substrate sheet that comprises (a) a plurality of rotatable elements that each (a1) comprises a respective magnetic pattern and (a2) is configured to rotate about an axis extending in a direction, and (b) a thermoplastic arranged so as oppose rotation by a respective rotatable element when the thermoplastic material is in a cool state and permit rotation by the element when the thermoplastic material is in a warmed state, applying a schedule of magnetic fields and heat so as to convert the magnetizable substrate sheet from a first folding state to a second folding state.
Aspect 33. The method of Aspect 32, wherein the second folding state is three-dimensional.
Aspect 34. The method of Aspect 32, wherein the schedule comprises applying a magnetic field to a first region of first and second regions of the magnetizable substrate sheet.
Aspect 35. The method of any one of Aspects 32-34, wherein the schedule comprises directing heat to a first region of first and second regions of the magnetizable substrate sheet.
Aspect 36. The method of any one of Aspects 32-35, wherein the method is performed such that in the second folding state, the magnetizable substrate sheet grasps an object.
Aspect 37. The method of any one of Aspects 32-35, wherein the method is performed such that in the second folding state, the magnetizable substrate sheet releases an object.
Aspect 38. The method of any one of Aspects 32-37, wherein the plurality of rotatable elements are arranged so as to define on the magnetizable substrate sheet a pixelated magnetic pattern that corresponds to a folding pattern and a folding sequence for converting of the magnetizable substrate sheet from the first folding state to the second folding state.
Aspect 39. A component, comprising: a plurality of articulable segments arranged circumferentially so as to define a first collapsable frustum and a second collapsable frustrum, each of the first collapsable frustum and the second collapsable frustum having a base, the first collapsable frustum and the second collapsable frustum extending away from their respective bases and converging toward one another, the first collapsable and second collapsable frustum converging at a plane and the component defining therein an opening at the plane, the component configured such that the first collapsable frustum and second collapsable frustrum are collapsable toward one another so as to attain one or more stable collapse states, the opening attaining at a given stable collapse state a cross-sectional dimension associated with that stable collapse state, and the greater a degree of collapse of the first collapsable frustum and the second collapsable frustum, the smaller the cross-sectional dimension of the opening.
Aspect 40. The component of Aspect 39, wherein the component achieves first and second stable collapse states, and wherein at the first stable collapse state, the opening achieves a first cross-sectional dimension, and at a second stable collapse state, the opening attains a second cross-sectional dimension, the first cross-sectional dimension and the second cross-sectional dimension differing from one another.
Aspect 41. The component of any one of Aspects 39-40, wherein an articulable segment bears a separate score line upon which the articulable segment folds in connection with the component reaching a particular stable collapse state.
Aspect 42. The component of any one of Aspects 39-41, wherein the base of the first collapsable frustum is associated with a first magnetic portion, wherein the base of the second collapsable frustum is associated with a second magnetic portion, and optionally wherein the first and second magnetic portions are of opposite magnetization.
Aspect 43. The component of Aspect 42, wherein application of an external magnetic field effects any one or more of (i) conversion of the component from an initial state to a first stable collapse state, and (ii) conversion of the component from a first stable collapse state to a second stable collapse state.
Aspect 44. The component of any one of Aspects 39-43, wherein the opening defines a cross-sectional dimension of no more than about 10 mm when the component is in an initial state and of no less than about 3 mm when the component is in a state of greatest collapse. The opening can be in the range of, for example, about 3 mm to about 10 mm, about 4 mm to about 9 mm, about 5 mm to about 8 mm, or from about 6 mm to about 7 mm. The foregoing ranges are, however, illustrative only.
Aspect 45. The component of any one of Aspects 39-44, wherein the opening is characterized as polygonal in profile.
Aspect 46. The component of Aspect 45, wherein the opening is characterized as square in profile.
Aspect 47. The component of any one of Aspects 39-46, further comprising a coating disposed about the opening.
Aspect 48. The component of any one of Aspects 39-47, wherein the first collapsable frustrum defines an opening at its base and wherein the second collapsable frustrum defines an opening at its base.
Aspect 49. The component of any one of Aspects 39-48, wherein the plurality of articulable segments are comprised in a single sheet of material.

The disclosed components can be used in a variety of applications. As but one application, a component according to the present disclosure can be used as a vessel band, such as a pulmonary artery band. This can be accomplished by, for example, installing the component about a subject's vessel, for example, the subject's main pulmonary artery. The component can then be articulated by application of a force or gradient—for example, a mechanical force or a magnetic field-so as to change the cross-sectional dimension of the opening within the component.

The disclosed components can also be used, for example, as grippers. Such a use can be accomplished by articulating the component so as to reduce the size of the opening within the component such that the component grips a fastener or other item located within the opening. The component can be used then to drive a fastener in, to pull a fastener out, or even as a tool to screw a fastener in or out.

What is claimed:

1. A method, comprising:
applying a magnetic field from a magnetic field source to a magnetizable substrate sheet that is in a first configuration,
the magnetizable substrate sheet comprising a first rotatable element that (i) comprises a first magnetic pattern and (ii) is configured to rotate about an axis extending in a first direction,
the first magnetic pattern comprising a region of a first magnetic polarity,
the first magnetic pattern optionally being characterized as pixelated,
the magnetic field rotating the first rotatable element as to convert the magnetizable substate sheet to a second configuration in which second configuration the first rotatable element magnetically affixes to a second element of the magnetizable substrate sheet,
the second element having a second magnetic pattern thereon,
the second magnetic pattern comprising a second magnetic polarity, and
the second element optionally being rotatable.

2. The method of claim 1, wherein the first rotatable element is rotatable about an axis extending in a second direction that is offset from the first direction.

3. The method of claim 1, further comprising effecting relative motion between the magnetic field source and the magnetizable substrate sheet.

4. The method of claim 1, wherein the first configuration of the magnetizable substrate sheet is substantially planar.

5. The method of claim 1, wherein the second configuration of the magnetizable substrate sheet is a folded configuration that corresponds to a step of a folding sequence that converts the magnetizable substrate sheet from the first configuration to a final configuration.

6. The method of claim 5, wherein the final configuration is three-dimensional.

7. The method of claim 1, further comprising any one or more of (i) defining the first magnetic pattern on the first rotatable element and (ii) applying the magnetic field according to a predetermined schedule.

8. The method of claim 1, wherein the magnetizable substrate sheet comprises a thermosensitive material, the thermosensitive material optionally comprising a thermoplastic.

9. The method of claim 9, further comprising application of sufficient heat to soften the thermosensitive material, the application of sufficient heat optionally placing the first rotatable element into a rotatable state.

10. A system, the system comprising:
a magnetic write head,
the magnetic write head being configured to define a magnetic pattern on a magnetizable substrate sheet; and
a magnetic coil,
the magnetic coil being configured to apply a magnetic field to a magnetizable substrate sheet so as to effect folding of the magnetizable substrate sheet.

11. The system of claim 10, further comprising an actuator configured to effect relative motion between the magnetizable substrate sheet and the magnetic write head, the system optionally comprising a heat source.

12. The system of claim 10, wherein the magnetic write head defines a first pole and a second pole, the magnetic write head being arranged such that a magnetic flux is communicated between the first pole and the second pole, and optionally wherein the magnetic flux is denser at one of the first pole and the second pole than at the other of the first pole and the second pole.

13. The system of claim 10, wherein the magnetizable substrate sheet comprises a plurality of elements, each of the elements being rotatable about at least one axis, the magnetizable substrate sheet optionally comprising a thermosensitive material arranged so as oppose rotation by an element when the thermosensitive material is in a cool state and permit rotation by the element when the thermosensitive material is in a warmed state.

14. The system of claim 10, further comprising a memory configured to store instructions for operating any one or more of the write head, the magnetic coil, and the heat source so as to convert the magnetizable substrate sheet from a first folding state to a second folding state, the instructions optionally comprising at least one pixelated magnetic image corresponding to (i) the second folding state of the magnetizable substrate sheet and/or (ii) an intermediate folding state of the magnetizable substrate sheet between the first folding state and the second folding state.

15. A component, comprising:
a plurality of articulable segments arranged circumferentially so as to define a first collapsable frustum and a second collapsable frustrum,
each of the first collapsable frustum and the second collapsable frustum having a base,
the first collapsable frustum and the second collapsable frustum extending away from their respective bases and converging toward one another,
the first collapsable and second collapsable frustum converging at a plane and the component defining therein an opening at the plane,
the component configured such that the first collapsable frustum and second collapsable frustrum are collapsable toward one another so as to attain one or more stable collapse states,
the opening attaining at a given stable collapse state a cross-sectional dimension associated with that stable collapse state, and
the greater a degree of collapse of the first collapsable frustum and the second collapsable frustum, the smaller the cross-sectional dimension of the opening.

16. The component of claim 15, wherein the component achieves first and second stable collapse states, and wherein at the first stable collapse state, the opening achieves a first cross-sectional dimension, and at a second stable collapse state, the opening attains a second cross-sectional dimension, the first cross-sectional dimension and the second cross-sectional dimension differing from one another.

17. The component of claim 15, wherein an articulable segment bears a separate score line upon which the articulable segment folds in connection with the component reaching a particular stable collapse state.

18. The component of claim 15, wherein the base of the first collapsable frustum is associated with a first magnetic portion, wherein the base of the second collapsable frustum is associated with a second magnetic portion, and optionally wherein the first and second magnetic portions are of opposite magnetization.

19. The component of claim 15, wherein application of an external magnetic field effects any one or more of (i) conversion of the component from an initial state to a first stable collapse state, and (ii) conversion of the component from a first stable collapse state to a second stable collapse state.

20. The component of claim 15, wherein the opening defines a cross-sectional dimension of no more than about 10 mm when the component is in an initial state and of no less than about 3 mm when the component is in a state of greatest collapse.
